(19) United States
(12) Patent Application Publication
(10) Pub. No.: US 2025/0103611 A1
(43) Pub. Date: Mar. 27, 2025

(54) SYSTEMS AND METHODS FOR INTERACTION AMONG MAINFRAME AND NON-MAINFRAME ENVIRONMENTS

(71) Applicant: VIRTUALZ COMPUTING CORPORATION, Minneapolis, MN (US)

(72) Inventors: Vincent R. RE, Southport, NC (US); Jeanne M. GLASS, White Bear Lake, MN (US); Dustin W. FROYUM, Golden Valley, MN (US); Marc S. SOKOL, Palm Harbor, FL (US)

(73) Assignee: VIRTUALZ COMPUTING CORPORATION, Minneapolis, MN (US)

(21) Appl. No.: 18/972,775

(22) Filed: Dec. 6, 2024

Related U.S. Application Data
(63) Continuation-in-part of application No. 17/957,030, filed on Sep. 30, 2022.

(51) Int. Cl. G06F 16/25

(52) U.S. Cl. CPC G06F 16/258

(57) ABSTRACT

A method includes monitoring mainframe management data in a mainframe environment in real time and receiving messages of the mainframe management data. A mainframe dataset in the mainframe environment is accessed and metadata defining the structure of data in the mainframe dataset is read. A target database outside of the mainframe environment is identified data in the mainframe dataset is parsed into a series of field names and values. The messages of the mainframe management data are transformed into a format readable by the target database. The data in the mainframe environment is transformed into database data comprising table, column and row identifiers. The transformed messages and the database data are transmitted from the mainframe environment to the target database.

### CROSS-REFERENCE TO RELATED APPLICATION

This application is a continuation-in-part of and claims priority to U.S. patent application Ser. No. 17/957,030, filed Sep. 30, 2022, the entire disclosure of which is hereby incorporated by reference herein in its entirety.

### BACKGROUND

The disclosure relates generally to mainframe operations, and more specifically to a system and method for interaction among mainframe and non-mainframe environments.

### BRIEF SUMMARY

According to one aspect of the present disclosure, a method includes monitoring mainframe management data in a mainframe environment in real time and receiving messages of the mainframe management data. A mainframe dataset in the mainframe environment is accessed and metadata defining the structure of data in the mainframe dataset is read. A target database outside of the mainframe environment is identified data in the mainframe dataset is parsed into a series of field names and values. The messages of the mainframe management data are transformed into a format readable by the target database. The data in the mainframe environment is transformed into database data comprising table, column and row identifiers. The transformed messages and the database data are transmitted from the mainframe environment to the target database.

### BRIEF DESCRIPTION OF THE DRAWINGS

Aspects of the present disclosure are illustrated by way of example and are not limited by the accompanying figures with like references indicating like elements.

FIG. 1 illustrates a block diagram of a system for data sharing between mainframe and non-mainframe environments, in accordance with a particular non-limiting embodiment of the present disclosure.

FIG. 2 illustrates block diagram of an I/O request transformation, in accordance with a particular non-limiting embodiment.

FIG. 3 illustrates block diagram of an I/O request transformation, in accordance with a particular non-limiting embodiment.

FIG. 4 illustrates block diagram of an I/O request transformation, in accordance with a particular non-limiting embodiment.

FIG. 5 illustrates block diagram of an I/O request transformation, in accordance with a particular non-limiting embodiment.

FIG. 6 illustrates block diagram of an I/O request transformation, in accordance with a particular non-limiting embodiment.

FIG. 7 illustrates a flowchart of a method for data sharing between mainframe and non-mainframe environments, in accordance with another particular non-limiting embodiment of the present disclosure.

FIG. 8 illustrates a flowchart of a method for data sharing between mainframe and non-mainframe environments, in accordance with another particular non-limiting embodiment of the present disclosure.

FIG. 9 illustrates a flowchart of a method for data transformation.

### DETAILED DESCRIPTION

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely in hardware, entirely in software (including firmware, resident software, micro-code, etc.) or combining software and hardware implementation that may all generally be referred to herein as a “circuit,” “module,” “component,” or “system.” Moreover, any functionality described herein may be accomplished using hardware only, software only, or a combination of hardware and software in any module, component or system described herein. Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or an suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including a symbolic programming language such as Assembler, an object oriented programming language, such as JAVA®, SCALA®, SMALLTALK®, EIFFEL®, JADE®, EMERALD®, C++, C #, VB.NET, PYTHON® or the like, conventional procedural programming languages, such as the “C” programming language, VISUAL BASIC®, FORTRAN® 2003, Perl, COBOL 2002, PHP, ABAP®, dynamic programming languages such as PYTHON®, RUBY® and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN), a cellular network, or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to aspects of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The teachings of the present disclosure relate to the selective interaction of resources from a mainframe environment to a non-mainframe environment. A non-mainframe environment refers to any computing resource(s) (hardware and/or software) that operate using an operating system that is not a mainframe operating system, for example, Windows, Linux, Unix, and iOS. In general, any mainframe environment employs a “proprietary” input/output (I/O) system, meaning that non-mainframe resources cannot gain access to or interact with mainframe resources since the I/O structure is not published or available to other computer resource providers. Non-mainframe resources, on the other hand, typically employ “open” and standards based-based client applications that allow non-mainframe resources to easily interact with each other. Thus, in accordance with a particular aspect of the present disclosure, a data sharing model is provided that allows proprietary I/O systems (e.g., mainframe resources) to be accessed by open and standards-based client applications (e.g., non-mainframe resources).

Many non-mainframe resources are utilized to build and operate public, private or hybrid cloud environments that leverage non-mainframe resources. For purposes of illustration throughout this description, reference is made to a “cloud environment.” Such reference is intended to mean non-mainframe resources that operate as a public, private or hybrid cloud using non-mainframe resources. It should be recognized by those of ordinary skill in the art, that any non-mainframe computing resource(s) could be used in lieu of or in addition to the cloud environment discussed herein. The use of cloud environment is provided as one example, but it not intending to be limited to a “cloud” but instead could be replaced by or include any non-mainframe resources.

A mainframe is a powerful, large-scale computer typically used by organizations for critical applications, such as bulk data processing, large-scale transaction processing, and enterprise resource planning (ERP). Mainframes are known for their high reliability, availability, and security, making them ideal for industries like banking, insurance, and government. Some key characteristics of mainframes include: 1. High Performance: Mainframes are designed to handle vast amounts of data and support thousands of simultaneous users or processes. 2. Reliability: Mainframes have built-in redundancy and are engineered to operate continuously with minimal downtime. 3. Scalability: These systems can scale to meet the growing demands of an organization, both in terms of data storage and processing power. 4. Security: Mainframes provide strong security features to protect sensitive data and support complex access controls. 5. Batch and Transaction Processing: They are particularly suited for environments where large volumes of data must be processed in batch or in real-time transaction processing. Historically, mainframes were the cornerstone of large organizations' IT infrastructure, and while their role has evolved with the rise of distributed computing and cloud technologies, they continue to be essential for many large enterprises.

A mainframe computer is large but not as large as supercomputer and has more processing power than some other classes of computers, such as mini-computers, servers, workstations, and personal computers. Mainframe computers are often used as servers within an enterprise. The term mainframe is typically used to distinguish high-end commercial computers (i.e., mainframes) from less powerful machines.

Modern mainframe design is characterized less by raw computational speed and more by design that allows, inter alia: (i) redundant internal engineering resulting in high reliability and security; (ii) extensive input-output (“I/O”) facilities with the ability to offload to separate engines; (iii) strict backward compatibility with older software; (iv) high hardware and computational utilization rates through virtualization to support workload isolation and massive throughput; and (v) the ability to dynamically and non-disruptively increase or decrease capacity (e.g., processors and memory or additional connected mainframes) as needs change.

Processing capacity of the mainframe computers is often measured in terms of millions of service units (MSUs) per hour that are used to execute tasks. Mainframe customers are often charged for their software application that runs on mainframe based on peak MSU consumption (i.e., the highest amount over a certain period of time, or a predetermined period of time (certain time of day(s), certain days, certain week(s), certain month(s), etc.)).

The high stability and reliability of a mainframe enables these machines to run uninterrupted for very long periods of time, with mean time between failures (MTBF) often measured in decades. Mainframes have high availability, one of the primary reasons for their longevity, since they are often used in applications where downtime would be costly or catastrophic. The term reliability, availability, and serviceability (RAS) is a defining characteristic of mainframe computers. In addition, mainframes are typically more secure than other computer types. For example, the National Institute of Standards and Technology vulnerabilities database rates traditional mainframes such as IBM Z (previously called z Systems, System z and zSeries), as among the most secure with vulnerabilities in the low single digits as compared with thousands for Windows, UNIX, and Linux.

In general, mainframes are designed to handle very high volume input and output (I/O) and emphasize throughput computing. It is common in mainframes to deal with massive databases and files. Terabyte to Petabyte-size record files are not unusual in the mainframe environment. Compared to a typical PC, mainframes commonly have hundreds to thousands of times as much computer storage online, and can access it reasonably quickly.

### Database File Structure

The file structure of data stored on a mainframe is highly organized and optimized for performance, reliability, and scalability. Mainframes typically use specialized file systems and data management methods, which allow efficient access to large amounts of data and ensure that the data is stored securely and with high availability. The file structure can vary depending on the type of data, the applications being used, and the specific mainframe environment.

Mainframe systems store data in data sets. A data set is the main unit of data storage in a mainframe. It is somewhat analogous to a file in other computing systems but can have a more complex structure and additional attributes. Data sets are typically stored on Direct Access Storage Devices (DASD), such as hard disks or SSDs, and can also be stored on tape for archival purposes. There are several types of data sets used in mainframes. Sequential Data Sets are the simplest and most basic type of data set. Data is stored sequentially (one record after another) and can be read or written in order. These are used for applications where the data needs to be processed in a specific order (e.g., batch processing). Partitioned Data Sets (PDS) are collections of sequential data sets. A PDS allows multiple files (members) to be grouped together in a single dataset. This is commonly used for program libraries, where each member is a separate source code file or executable. Partitioned Data Sets Extended (PDSE) are an enhanced version of PDS, offering better management and performance. PDSEs are more flexible and allow dynamic allocation and better storage utilization. VSAM Data Sets (Virtual Storage Access Method) are more complex and high-performance data set used for handling large amounts of data with indexing. VSAM data sets are used when efficient data access is critical, and they support features like indexing and direct access. VSAM is commonly used in online transaction processing (OLTP) systems and large databases.

The teachings disclosed herein also support low level I/O instructions and conversion for low level programming. For example mainframe datasets of Execute Channel Program (EXCP) instructions can be read, understood and converted.

EXCP refers to a command or instruction used in the IBM z/OS operating system to initiate I/O operations. Specifically, EXCP is used for Direct Access Storage Device (DASD) and tape device operations. It allows the operating system or applications to communicate directly with I/O devices for reading or writing data. A channel program is a sequence of I/O operations that the channel subsystem executes. The channel subsystem is responsible for managing the flow of data between memory and I/O devices (e.g., disks, tapes). EXCP is a way for an application to trigger the execution of such channel programs to interact with I/O devices. EXCP is used to perform I/O operations, such as reading data from or writing data to a disk or tape drive. The EXCP interface is often used in older programs and utilities that need to directly control I/O operations. It provides a mechanism for low-level access to I/O devices, bypassing some of the more abstracted or higher-level I/O interfaces that might be provided by the operating system.

When a program needs to perform an I/O operation, it issues an EXCP command. This command specifies the channel program that defines the sequence of operations. The channel subsystem processes the channel program and executes the I/O operation (e.g., read or write) on the relevant device. Once the operation is complete, control is returned to the application.

While EXCP is used for low-level I/O operations, higher-level I/O services in z/OS (e.g., SVC (Supervisor Call) I/O routines, z/OS UNIX file system calls, or open/close/read/write system calls) abstract away the complexities of working with channels directly. EXCP is often used for performance-sensitive applications or utilities that need direct control over I/O devices, especially in environments that need to optimize for speed and efficiency, such as databases, large-scale batch jobs, or data management systems. For example, in a mainframe environment where a program needs to read or write data to a Direct Access Storage Device (DASD), EXCP could be used to initiate the I/O operation on the device by directly interacting with the channel subsystem. EXCP could also be used for handling operations on tape drives, especially for batch data transfers or backup tasks.

In general, EXCP is an IBM mainframe instruction used to initiate low-level I/O operations directly with hardware devices such as disks and tapes. It is primarily used in legacy systems to manage I/O operations efficiently and is part of the channel subsystem architecture of mainframes.

Mainframes use specialized file systems to organize data within data sets. The file system provides an abstraction layer that allows applications to interact with data sets in a structured way. Mainframe file systems are designed to handle large-scale data storage efficiently. Common file systems include (i) z/OS File System (zFS)—A hierarchical file system used in IBM mainframes running z/OS. It is similar to modern UNIX-like file systems and provides a more flexible way to store and organize files with directories and paths; and (ii) HFS (Hierarchical File System)—A file system that organizes data in a hierarchical manner, similar to file systems used on UNIX-based operating systems. It allows for files to be stored in directories and subdirectories.

Mainframe systems use catalogs to manage data sets. A catalog is a special file that stores metadata about data sets, such as their names, attributes, location on the storage media, and access permissions. Catalogs help the system quickly locate data sets and ensure efficient management. A catalog can contain entries for both data sets and libraries. A System Catalog is a system-level catalog that maintains metadata for all data sets and libraries on the system. A User Catalog is a catalog that is specific to a particular user or application, often providing faster access to the most relevant data sets for that user.

In addition to the sequential and partitioned data set structures, mainframes often use indexes to improve data retrieval. This is particularly true for VSAM data sets, where records are indexed by key values. Indexes allow for quick lookups and efficient search operations within large datasets. Indexing helps optimize access by storing pointers to data, so instead of reading data sequentially, the system can jump to the correct location directly. Each record in indexed data sets may have one or more key fields (“keys”) that are used for sorting, retrieval, and maintaining data integrity.

Within a data set, data is typically organized into records. A record is a collection of related data elements, such as a customer's name, address, and account number. These records are stored in blocks, which are contiguous sections of storage space. In sequential data sets, records are often of fixed length, while in other data sets (like VSAM), records can be variable in size. Blocks are used to group records together, and each block typically contains multiple records. The block size is typically optimized for the underlying storage media to ensure efficient read and write operations.

Mainframe systems also employ specialized methods for managing and accessing data. For example, Virtual Storage Access Method (VSAM) is a set of techniques used to manage data in a way that provides quick access and high performance. It is the standard method for handling large datasets on IBM mainframes. Mainframe systems use optimized methods for reading, writing, and updating records. For example, when working with large volumes of transaction data, batch processing and indexing are often used to manage the records efficiently.

Data stored in mainframes can be accessed in different ways, depending on the access method used by the application or program. These methods can include sequential access, direct access, and indexed access.

In general, the file structure of data stored on a mainframe is highly organized to meet the demands of large-scale, high-performance, and reliable data storage. Data is typically stored in data sets, which can be sequential, partitioned, or indexed. Mainframes use specialized file systems, such as zFS or HFS, along with cataloging systems to manage and quickly access the data. The use of indexing, records, and blocks allows efficient data retrieval, while methods like VSAM and virtual storage provide robust and scalable data management.

Due to the complex and sophisticated nature of mainframes, they often require corresponding complex and sophisticated software in order to run properly and efficiently. Due to these complexities, mainframes are very expensive to purchase and maintain. Moreover, continued use of the software typically requires the payment of substantial fees either annually or on a per “use” basis. The per “use” basis may measure the number of transactions, the amount of resources used over a period of time and may also take into account the number of mainframes having a particular application installed thereon, or the number of applications on a particular mainframe.

Many enterprises rely upon mainframes for their ability to handle large datasets, and enterprise-critical applications that require the sheer power and reliability of the mainframe. An enterprise that relies upon mainframe computing typically employs one or more mainframe environments that each employ multiple applications running simultaneously, many or all of which rely upon at least one common dataset within the mainframe environment. Moreover, The idea of concurrency or sharing with integrity is important too . . . if multiple applications share a dataset, it's important that updates be handled in a consistent way so that the applications don't inadvertently “interfere” with one another. In accordance with the teachings of the present disclosure, access from any particular mainframe application(s) can be provided to non-mainframe storage resources in order to access, copy and/or update data stored on any one of multiple non-mainframe resources, with no loss of integrity.

Over time, the cost of computing resources outside of a mainframe environment has dropped dramatically to a point of widespread affordability, while the cost of computing resources and data storage inside the mainframe environment has decreased, but remains relatively expensive since its initial costs were astronomically high. In some cases, costs associated with running a mainframe have risen. Thus, there is a desire among many enterprises to reduce their reliance on mainframe resources, and leverage non-mainframe resources instead. Non-mainframe resources include computer resources and software that operate in an operating system that is not a mainframe operating system, for example, Windows, Linux and Unix.

The widespread availability of alternative computing platforms and cloud computing resources provides attractive alternatives to solely relying on resources in a mainframe environment. In general, certain applications are best suited to the mainframe; others are best suited to other computing platforms (e.g., the cloud). Typically, customers have to pick one or the other for each application, and mainframe applications and cloud applications cannot talk to each other today. The teachings of the present disclosure allow interaction among mainframe environments and non-mainframe environments such that data and files may be shared among the environments. For example, data can be shared back and forth across applications and across platforms (e.g., mainframe vs. non-mainframe). This allows for a hybrid approach as opposed to one or the other alternatives. Enterprises are therefore motivated to move all but their most enterprise-critical applications and computing resources off of the mainframe, to less expensive computing resources. Transitioning from mainframe to cloud services, for example, allows enterprises to “modernize” their businesses, reduce costs and increase agility.

Applications running on the mainframe typically share access to data stored within the mainframe. For example, multiple applications running in an z/OS environment employing virtual storage access method (VSAM) can share datasets within the mainframe environment among multiple applications. Those sharing applications can all be updating that same shared VSAM file, and the system coordinates these updates such that the applications don't interfere with each other or corrupt data. However, data in this environment lacks the structure of, for example, a typical database. For example, VSAM files can include binary, characters, dates and fields, and lack the structure of file/column/row of many databases. Thus, it becomes difficult for an application running outside of the mainframe environment to “interact” with the mainframe environment by leveraging any applications within the mainframe environment or relying upon any datasets within the mainframe environment. Similarly, it is difficult for the mainframe to interact with an application(s) running in a non-mainframe environment, in order to leverage resources and/or stored data residing on such non-mainframe resources.

### Database File Structure

One reason for the incompatibility of mainframe and non-mainframe environments for sharing data is the differences in the structure of the stored data. For example, as described more fully below, data in a non-mainframe environment is typically stored in databases. Databases are generally arranged in rows and columns, and the associated files include embedded metadata. Metadata in the context of a database file refers to data that describes and provides information about the structure, organization, and properties of the actual data stored in the database. Metadata helps both the database management system (DBMS) and users understand how the data is stored, accessed, and managed, but it doesn't contain the actual data itself. In contrast, files stored in a mainframe environment do not include metadata. Instead, such files rely upon catalogs (e.g., files that store metadata about data sets, such as their names, attributes, location on the storage media, and access permissions).

The file structure of data stored in a database refers to how the database organizes, stores, and retrieves data. This structure is crucial for the efficient performance of the database system (DBMS), and it varies depending on the type of DBMS (e.g., relational, NoSQL) and the specific database implementation. However, there are common patterns and techniques used across most databases.

At a high level, most databases organize data into tables, which are logical structures where data is stored in rows and columns. The logical structure represents how data is conceptualized by the user, but the actual storage on disk is much more complex. Each row in a table represents a record or an instance of data (e.g., a single customer's information). Each column represents an attribute or field of the record (e.g., name, address, date of birth). At the physical level, data is typically stored in fixed-size pages (also known as blocks). A page is the smallest unit of storage and data retrieval in a database (the size of a page can vary depending on the DBMS, but it typically ranges from 4 KB to 64 KB). A page contains multiple rows (records) or part of a row, depending on the size of the records and the page. For example, a table row might fit completely within a single page or span multiple pages.

Most databases use indexes to optimize query performance. Indexes are separate data structures that store pointers to the actual data records in the table. The file structure for indexes is designed to facilitate fast lookups, allowing the database to find rows efficiently based on specific column values (usually primary or secondary keys). In some cases, hash-based indexing is used, where a hash function computes a value that can be used to directly find data, typically used in scenarios where equality searches are common.

A data file is the actual file on disk that holds the physical storage of database records, tables, indexes, and other objects. A database might use one or more data files, depending on the size of the data and the DBMS configuration.

Most relational databases maintain transaction log files (also known as redo log files or write-ahead logs). These log files are used to track changes made to the database for recovery purposes, ensuring data integrity in case of a crash or failure. The log records every operation that modifies the database, including insertions, updates, and deletions. This enables the DBMS to recover committed transactions and roll back uncommitted ones during a system failure.

Different types of databases are structured differently. For example, Relational Databases (e.g., MySQL, PostgreSQL) are structured differently than NoSQL databases (e.g., MongoDB, Cassandra, etc.).

The file structure of data in a database involves several layers of organization designed to optimize storage, retrieval, and transaction integrity.

In accordance with particular embodiments, a mainframe software product is provided that is designed to run on a mainframe computer, for example, an IBM System Z mainframe computer running IBM's z/OS operating system. In these particular embodiments, TCP/IP network connectivity is provided from the mainframe computer to any of the non-mainframe storage systems the user wants to access from their z/OS applications.

In particular embodiments, mainframe applications are enabled to seamlessly access non-mainframe “data sources”—which may consist of an open-ended set of on-premises and/or remote filesystems, devices and services. For example, certain software may be deeply integrated with z/OS JCL and data management constructs, enabling nearly any mainframe application to reference the above referenced data sources.

For example, particular embodiments leverage a robust installable device driver architecture that makes it easy to integrate arbitrary data sources with the mainframe software product including popular cloud storage systems like Amazon S3, Google Drive, Microsoft OneDrive, Dropbox, Box and many others. The device driver architecture may be based on important open standards, making many implementations immediately available to users by simply reusing existing software.

The above mentioned device driver architecture may also support technologies such as the iSCSI standard, a popular protocol that enables high-performance and low-cost storage devices to be accessed over a TCP/IP network. This feature enables low-cost storage devices from a variety of vendors to be connected to mainframes and accessed by many mainframe applications.

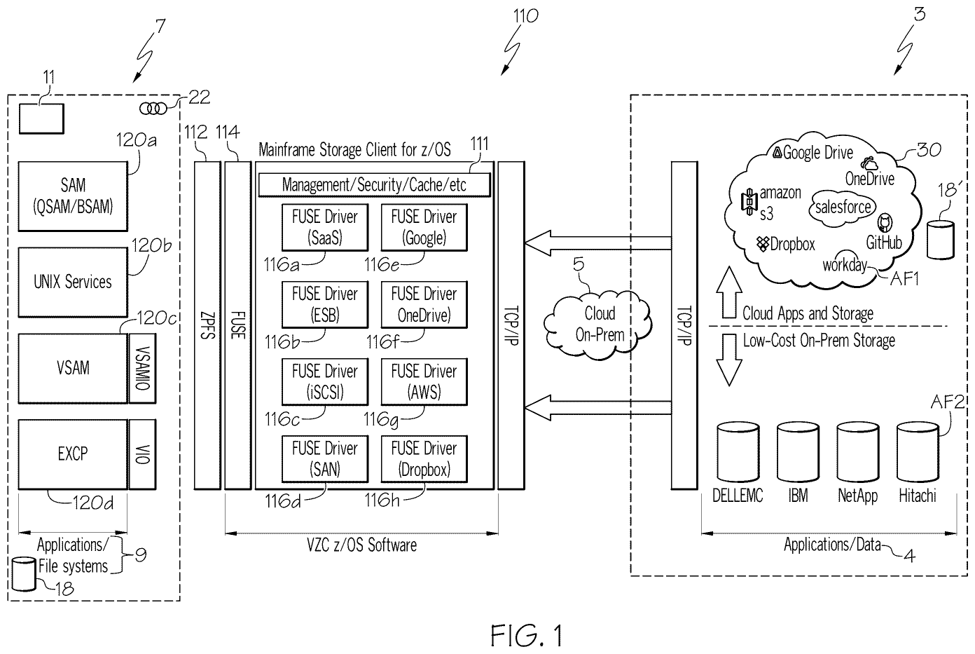

FIG. 1 illustrates a non-mainframe network environment 3 communicatively coupled with a mainframe environment 7, using a network 5. Mainframe environment 7 is a computer network environment comprising hardware and/or software supporting applications and filesystems operating and stored on it. In the illustrated embodiment, the mainframe environment is running the z/OS operating system, but in alternative embodiments, mainframe environment 7 may be running other operating systems in addition to or in lieu of z/OS.

Applications and filesystems 9 comprise one or more applications and files organized according to the conventions of the mainframe environment 7, which often include proprietary formats. In the illustrated embodiment, z/OS applications and files stored on mainframe storage devices are being accessed with VSAM and SAM (BSAM/QSAM/BPAM) access methods, although other methods are available. For example, the teachings of the present disclosure envision other operating systems, file storage media and access protocols as well, including SQL and non-SQL databases, hierarchical or network databases, and any other proprietary format.

Network 5 may be any combination of hardware and software that can be used to connect the client and server computer. In the illustrated embodiment, the TCP/IP network protocol is envisioned. Typically, the network layer includes a networkable file access protocol, such as some variant of NFS, SMB, or other common network file sharing protocols. Other protocols and devices can be used as well, such as SNA or NetBIOS networks, or hardware communications devices that provide a channel between client and server (such as two mainframes connected by channel-to-channel adapters, or two UNIX computers connected by a serial port).

Non-mainframe network environment 3 may comprise any type of computer(s) and operating system(s) that can be connected to computers or servers over the designated network. In the illustrated embodiment, non-mainframe network environment 3 comprises computers based on Intel hardware platforms running Windows or Linux operating systems, both as stand-alone computers and as entities running in popular cloud environments. Any client computer capable of connecting to the server computer can be used, including mobile devices, IoT devices, smartphones, tablets, various architectures of servers, etc.

Applications/data 4 comprise applications and data that are software that may be written in any programming language that accesses data using standards-based I/O protocols. In the illustrated embodiment, client applications/data 4 may be developed using one or more programming languages including C/C++, Java and COBOL programming languages, and they access data using POSIX-defined file I/O APIs. The present disclosure also envisions other data access protocols and APIs, including common database products (such as JDBC/ODBC), so-called No-SQL protocols (as found in Hadoop, Cassandra, MongoDB and others), web service data APIs such as ODATA, and common proprietary APIs such as the BerkeleyDB indexed file API.

The teachings of the present disclosure provide systems and methods that enable applications/filesystems 9 of mainframe environment 7 to be accessed from the applications/data 4 of the client computer, even though the data on the client computer may be stored in incompatible and proprietary ways.

Such capability is provided even though there may be differences in data formats that impact the way data is stored and processed across non-mainframe network environment 3 and mainframe environment 7. An example may include a z/OS VSAM file, commonly encoded in an EBCDIC codepage, versus a Windows or Linux application coded so as to expect data in an ASCII or UNICODE code page. Using metadata describing the server's data layouts, the teachings of the present disclosure allow the system to automatically and in real-time transform between the native data structures found on the physical storage medium, to the formats expected by the client application. The transformation occurs at a field-by-field level and anticipates different character formats, number representation formats (ie, “big-endian” versus “little endian”), structure alignments and other complex transformations. Multiple different transformations can be in place concurrently if multiple applications access data from client computers having different data structure expectations.

The teachings disclosed herein also provide an additional layer of security and management that occurs on the mainframe environment 7 and non-mainframe network environment 3, enabling administrators of the client computer(s) 3 to have control over the applications/filesystems that may access the system, the entitlements they may have, and whether their activity is audited. Such security and management may comprise applications resident upon and/or in communication with management/security application 111 of mainframe storage client 110.

FIG. 1 illustrates an architecture of software and hardware, in accordance with a particular embodiment of the present disclosure, to accomplish some or all of the features and functions described herein. In general, the architecture comprises three architectural components (i) a set of components 112 and 114 integrating a mainframe storage client 110 with existing mainframe applications 120a-d (e.g., z/OS applications); (ii) the mainframe storage client 110 itself; (iii) drivers 116a-h (or “connectors”) to various storage services that reside in a non-mainframe environment.

In the illustrated embodiment, mainframe storage client 110 comprises a z/OS storage client meaning that is may reside on a mainframe server running on the z/OS operating system. Thus, mainframe storage client 110 may be running on a mainframe server. However, mainframe storage client may also be configured to run on any computer and/or server outside of the mainframe environment (e.g., within non-mainframe environment 3). However, it should be appreciated that the mainframe storage client could reside on practically any mainframe server and/or non-mainframe server. The features and functions of the present disclosure may be accomplished upon a mainframe storage client that includes hardware and/or software resident upon a mainframe server, non-mainframe server, or distributed across both. The “storage client” may reside entirely outside of the mainframe environment, e.g., in a non-mainframe environment. Mainframe storage client 110 may include all software and hardware necessary to accomplish the features and functions described in the present disclosure. In other embodiments, some or all of such software and hardware may reside outside of the mainframe environment.

Together, these components provide the interfaces that enable mainframe applications/filesystems to interface with mainframe storage client 110. In the illustrated embodiment, mainframe applications/filesystems comprise existing z/OS applications, that interface with a mainframe storage client running a z/OS operating system. One goal of particular embodiments of the present disclosure is to provide seamless integration to existing applications while requiring no changes or proprietary APIs in order to integrate with such applications. Thus, this layer is designed to plug into the z/OS operating system's filesystem design in a way that makes mainframe storage client 110 appear to the mainframe server and mainframe applications/filesystems as any other mainframe filesystem would appear to the mainframe server and mainframe applications/filesystems.

There are four subcomponents present—the path any given application of applications/filesystem 9 takes to interface with targets such as non-mainframe applications/data 4 depends on how the mainframe application chooses to perform file I/O. Several examples will be provided below.

### Traditional Sequential File Processing

In particular embodiments, the teachings of the present disclosure define interfaces for sequential file processing to support applications based on IBM's QSAM or BSAM access methods. This category includes most traditional z/OS applications that require sequential record processing, including COBOL, C, PLI, assembler language applications, system utilities and vendor software. These applications operate by invoking IBM's QSAM, BSAM or UNIX services interfaces, which are extended by the teachings disclosed herein, to work with mainframe storage client 110. In particular embodiments, this can be accomplished, in part, using IBM's built-in support for z/OS UNIX Services filesystems.

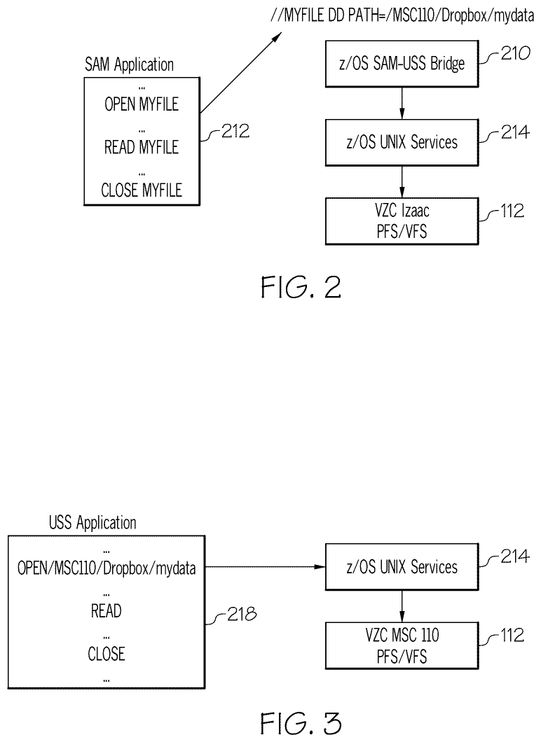

As one example, when an application accesses a SAM file, mainframe storage client 110 leverages built-in z/OS operating system capabilities that work together to result in application I/O requests being passed to the mainframe storage client filesystem (described below). The flow is illustrated in FIG. 2.

The z/OS SAM-USS Bridge 210 shown in FIG. 2 is a z/OS component (e.g., hardware and/or software) that maps QSAM and BSAM API calls 212 into equivalent UNIX Services (USS) functions 214. This component allows applications to operate using normal QSAM and BSAM constructs, even though the underlying filesystem resources may be implemented as z/OS UNIX Services resources. Mainframe storage client 110 leverages this component (e.g., PFS/VFS 112) to support legacy SAM and QSAM applications.

### z/OS UNIX Services Applications

Applications that leverage IBM's z/OS UNIX Services (USS) subsystem are conceptually very similar to the SAM applications described in the previous section. The teachings of the present disclosure define interfaces for sequential file processing to support applications based on IBM's QSAM or BSAM access methods. These applications may also access mainframe storage client 110 using IBM's built-in support for z/OS UNIX Services filesystems, which may be supported by the teachings included herein, in particular embodiments.

When an application accesses a z/OS UNIX Services (e.g., USS Application file, the application communicates directly with the z/OS UNIX Services kernel, bypassing the z/OS SAM-USS bridge shown in the previous section. The flow changes slightly from FIG. 2, to look like the diagram of FIG. 3.

By communicating more directly with mainframe storage client 110, applications can use a more comprehensive set of file I/O functions, such as positioning the file to different records, truncating files, creating directories and so forth. Using the mainframe storage client 110 of the present invention, the mainframe application of mainframe applications/filesystems 9 is free to use the full set of POSIX I/O functions supported by z/OS.

### VSAM Applications

Many mainframe applications are coded to use IBM's VSAM access method instead of QSAM, BSAM or UNIX Services. VSAM provides many sophisticated functions, such as organizing records within a file by keys or providing access to records based on a relative record number. Applications needing to process records directly by key or record number typically would use VSAM.

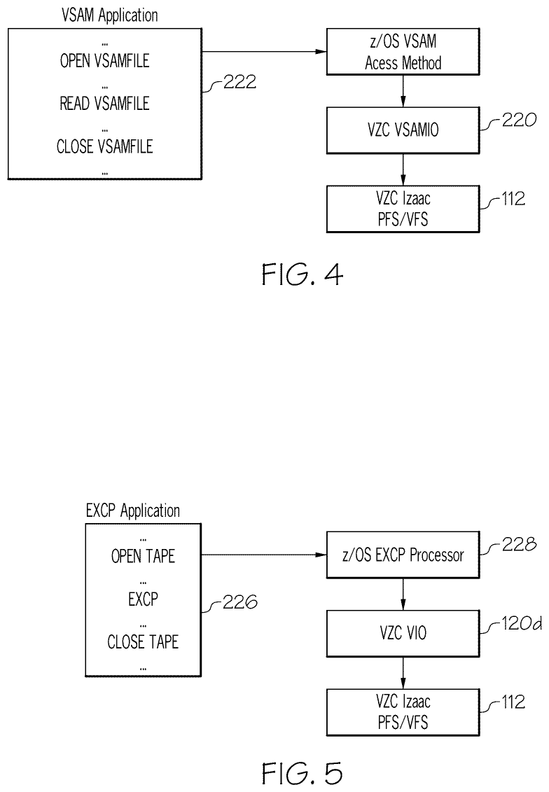

To support VSAM, the mainframe storage client 110 of the present disclosure includes the VSAMIO component 220 shown in FIG. 4.

With reference to FIG. 4, the VSAM application 222 operates unchanged in order to communication with mainframe storage client 110—the VSAM application 222 of mainframe applications/filesystems 9 uses the full set of VSAM API functions to process VSAM files in any manner it needs to or typically does, and these requests continue to communicate directly to the z/OS VSAM access method routines.

Within VSAM is a “media manager” component that handles physical I/O to the storage devices holding VSAM objects. In particular embodiments of the present disclosure, mainframe storage client 110 intercepts and extends this system component such that requests managed by mainframe storage client 110 are automatically routed to the filesystem associated with mainframe storage client 110, for processing.

When a VSAM API request is issued, the processing still occurs in the normal manner, up through the time that the VSAM access method routines would perform I/O to the disk containing the necessary VSAM data. An VSAMIO intercept (e.g., VSAMIO 220) of the mainframe storage client 110 hooks into the process, taking over the responsibility for reading and writing the data blocks that VSAM requires. This approach allows low-cost storage devices and cloud storage providers to be used directly as though they were standard VSAM storage devices, potentially dramatically lowering operating cost for many applications.

### Device-specific I/O Emulation

Some mainframe applications are coded to interact only with specific types of devices. Typically, these applications rely on a technique called channel programming—a technique for sending low-level device-specific commands to an I/O device. A common example are certain mainframe backup/restore applications that typically only write backup datasets to tape devices. Instead of using normal operating system functions to access tape files, these applications generate low-level I/O device commands that position the tape to the desired location and then efficiently transfer data to the tape device in large blocks.

In accordance with particular embodiments of the present disclosure, supporting device-specific applications with the mainframe storage client utilizes a virtualization of the target device (i.e., a non-mainframe application of non-mainframe applications/data 4) that's capable of acting as a “bridge” between the application and mainframe storage client 110. The non-mainframe application would believe it is operating against a traditional I/O device, then these special channel programs would be interpreted and processed by mainframe storage client 100, emulating the behavior of a physical device such as a tape drive. An example of such an architecture is reflected in FIG. 5.

With reference to FIG. 5, the application 226 generates device-specific channel programs using EXCP (EXecute Channel Program), and these requests are processed by the z/OS EXCP processor 228. Just as the description above regarding intercepting VSAM I/O requests to support VSAM, here, we intercept certain EXCP operations in order to provide a simulation of a standard mainframe I/O device (e.g., tape device). The channel program is decoded and transformed into a series of block reads and writes that are processed by the filesystem of the mainframe storage client 110.

Depending on the type of device being emulated, mainframe storage client 110 may access the application's channel program, decode the individual channel commands and transform them to a series of calls to the mainframe storage client 110. This technique permits any mainframe storage client 110 data source to emulate the desired device.

### The Filesystem and Server of the Mainframe Storage Client

At the center of the mainframe storage client 110 is the filesystem and server. Together, these components form the visible manifestation of the mainframe storage client product.

Throughout this specification, the term “FUSE” is a reference to “Filesystems in USErspace”, a popular open-source standard for implementing filesystems in a simplified manner. It is described at https://www.kernel.org/doc/html/latest/filesystems/fuse.html.

Broadly speaking, the mainframe storage client 110 is an implementation of a z/OS UNIX Services logical filesystem, as documented in z/OS® UNIX System Services File System Interface Reference (IBM publication number SA23-2285). This standard provides a documented facility to integrate new logical filesystems into z/OS by implementing a collection of well-defined programming interfaces. By following these conventions, z/OS can be configured to allow Izaac to service Izaac filesystem requests on behalf of arbitrary z/OS applications.

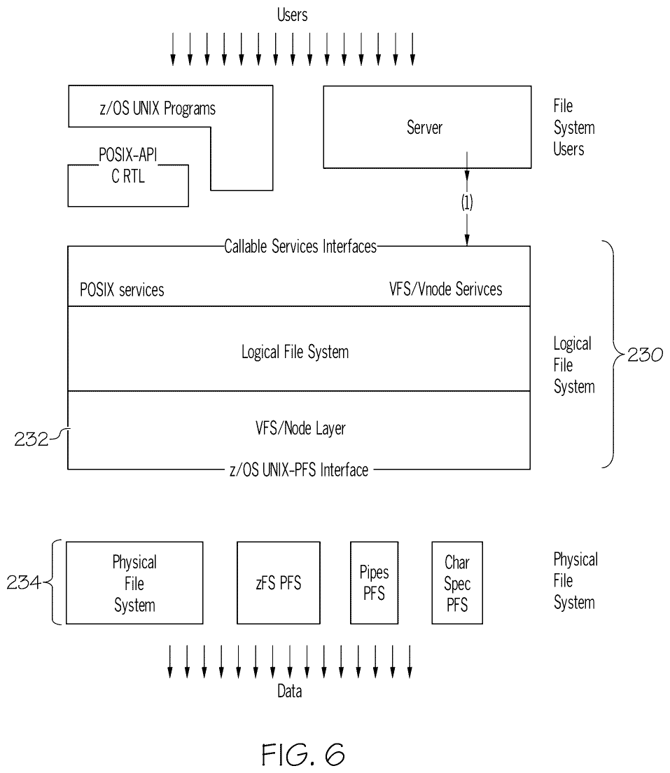

The overall logical filesystem design found in z/OS is structured as illustrated in FIG. 6, a diagram provided by IBM.

In accordance with the diagram above, mainframe storage client 110 server process operates identically to other z/OS logical file systems 230, processing messages and data requests from the operating system through the virtual file system (VFS) 232 and physical file system (PFS) 234 interfaces.

Unlike IBM's implementation, however, mainframe storage client 110 imposes a different structure at the lower part of the diagram of FIG. 6 to achieve data source independence and other important features. There are two goals:
1. Limit the need for highly proprietary z/OS interfaces that require specialized engineering logic. Normally, the interfaces between z/OS and logical filesystems is based on low-level mainframe capabilities, requiring considerable z/OS-specific coding in the implementation of these functions. The teachings of the present disclosure provide an approach that minimizes the need for specialized mainframe interfaces and expertise to improve the cost and performance of the solution.
2. Allow standards-based filesystem drivers to be incorporated into mainframe storage client 110 with minimal changes. Mainframe storage client 110 is intended to support a wide variety of data sources, from cloud storage like Amazon S3, Google Drive or Microsoft OneDrive, all the way to low-cost physical storage devices from Quantum, Netapp, Dell/EMC and others. To help mainframe storage client 110 achieve a broad range of supported services, the teachings of the present disclosure leverage existing technology in such a way that these device drivers can be shared from other computing platforms without requiring rewriting for z/OS.

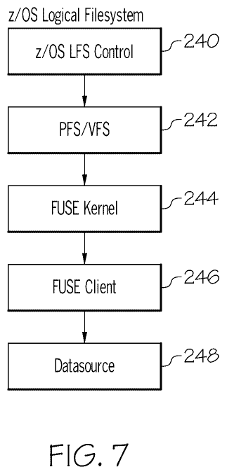

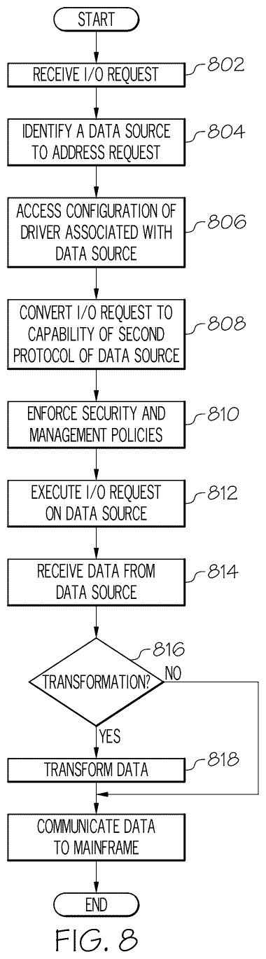

In particular embodiments, the goals discussed above lead to a design where the logical filesystem implementation is divided into several subcomponents, as illustrated in FIG. 7.

With reference to FIG. 7, processing begins with the set of functions defined by IBM's z/OS Logical File System control protocols 240. These functions largely correspond to filesystem activity: opening files, reading and writing data, and performing various file control functions. When triggered by applications performing file I/O against a non-mainframe data source managed by mainframe storage client 110, these functions are directed to a specific instance of mainframe storage client 110 that's been configured to handle requests for that filesystem.

The PFS/VFS layer 242 of mainframe storage client 110 is responsible for implementing the logical file system functions required by z/OS, and then marshalling/unmarshalling requests for the FUSE layer of mainframe storage client 110.

The PFS/VFS layer 242 of mainframe storage client 110 is also invoked directly under certain conditions, bypassing the z/OS LFS component. Examples would include the VSAM VSAMIO or VIO device emulation capabilities explained earlier. Generally, however it's invoked, the PFS/VFS subcomponent 242 of mainframe storage client 110 maps the set of logical filesystem calls to the FUSE equivalents.

The FUSE Kernel 244 of mainframe storage client 110 is responsible for communicating requests between the PFS/VFS of mainframe storage client 110 and one or more FUSE applications (e.g., FUSE client 246). Each data source has one or more FUSE applications running as distinct processes outside of the FUSE Kernel of mainframe storage client 110. As filesystems are mounted and accessed, the FUSE Kernel 244 of mainframe storage client 110 launches, tracks and communicates with the FUSE application 246 that's been configured to support that specific data source instance.

Although certain configurations are described herein, persons of ordinary skill in the art will recognize that there are many configurations possible. Some users may elect to run a single instance of mainframe storage client 110 that is connected to multiple data sources. In other implementations, it may be desirable to have many instances of mainframe storage client 110 running on a particular z/OS system, with each instance configured to connect to a different set of data sources. The optimum configuration varies depending on requirements for scalability, performance and security.

Configuration data provided to mainframe storage client 110 associates z/OS filesystem mountpoints with the PFS/VFS server of mainframe storage client 110, and then with the specific data source drivers required for that mountpoint. For example, the user might define a mountpoint at “/MSC110” in their filesystem and associate it with the filesystem of mainframe storage client 110. Within that single mountpoint, the user might have several subdirectories representing different data sources with a structure like this:
/MSC110
   /MSC110/Google→Google Drive
   /MSC110/→Dropbox
   /MSC110/Amazon→Amazon
   /MSC110/SAN→DELL/EMC

In the example layout above, an application referencing files in the/MSC110/Google directory would be referencing files in a Google Drive cloud repository, while files in the/MSC110/Amazon directory reference Amazon S3 files. This structure enables many different data sources to exist in parallel and to be accessed concurrently.

The FUSE client 246 is a distinct and separate process, running as a conventional unprivileged application on z/OS. The linkage between the FUSE kernel 244 and the FUSE client 246 relies on a high-performance message-passing implementation. Messages generally correspond to the parameters passed to the z/OS logical filesystem functions 240, sent by the FUSE kernel 244 to the appropriate FUSE client 246. The FUSE client 246 accepts these messages and communicates the request to the data source driver 248 (e.g., driver that corresponds to the source of the data of non-mainframe network environment 3; for example, the source of the data may be Dropbox in a particular embodiment).

The FUSE client 246 presents information to the data source driver 248 using the protocol defined by the LIBFUSE open-source protocol specification. This feature enables existing FUSE drivers that have been built for other platforms to be used with mainframe storage client 110 unchanged, greatly extending the reach of mainframe storage client 110.

The Datasource driver 248 of mainframe storage client 110 is an implementation of the FUSE standard driver as described in the link shown above. Mainframe storage client 110 adds several additional z/OS-specific features to streamline development and operation. Among the services provided are z/OS services, message queuing, data transformation, management alerting and so forth.

### The FUSE Runtime Environment and Drivers

FUSE data source device drivers of mainframe storage client 110 (“MSC110 Drivers”) are the final link in the path between the application and the data source it seeks to process. Communicating according to the protocol required by the targeted cloud service or physical device, the MSC110 Driver encapsulates and manages all aspects of exchanging data with the targeted service.

MSC110 Drivers are implementations of the FUSE standard described earlier, and in most cases, mainframe storage client 110 can operate with preexisting FUSE drivers developed by the open-source community. This approach provides mainframe storage client 110 access to a wide variety of data sources, including Amazon S3, Google Drive, DropBox and so forth, mainframe storage client 110 permits these and other FUSE drivers to be used concurrently in any combination.

Another example would be the use of FUSE drivers implementing the popular iSCSI standard, a low-level protocol for accessing physical storage devices and SAN services over a network. Using iSCSI, mainframe storage client 110 enables mainframe applications to be connected to many physical devices that previously had no direct connectivity to mainframes. This approach provides mainframe sites with high-performance access to low-cost storage devices.

The lifecycle of a driver of mainframe storage client 110 begins when the z/OS system initially mounts the target data source. Based on configuration data, the user initiates a mount operation, specifying the target filesystem type and other parameters. z/OS directs the request to the PFS/VFS of mainframe storage client 110 and mainframe storage client 110 in turn launches an instance of the FUSE Client of mainframe storage client 110 that loads and initializes the appropriate Driver of mainframe storage client 110 for that data source. In accordance with a non-limiting example of the present disclosure, the sequence is:
1. The PFS/VFS of mainframe storage client 110 is started by z/OS. Typically, this happens during system startup as part of the initialization of the z/OS UNIX Services system component.
2. Once initialized, the user can issue a “mount” command for a data source managed by mainframe storage client 110.
3. z/OS communicates the mount command and other parameters to the PFS/VFS of mainframe storage client 110. Depending on configuration, there can be one PFS/VFS process of mainframe storage client 110 or several. When several PFS/VFS instances of mainframe storage client 110 exist, the mount command is passed to the appropriate instance.
4. The PFS/VFS of mainframe storage client 110 verifies the request and launches a new instance of the FUSE Client of mainframe storage client 110 to handle future access requests for the desired mountpoint. The FUSE Client of mainframe storage client 110 runs as a distinct process, separate from the PFS/VFS mainframe storage client 110.
5. The PFS/VFS mainframe storage client 110 periodically monitors the FUSE client for health, availability and status in order to cleanup automatically should errors occur.
6. The FUSE Client of mainframe storage client 110 loads and initializes the FUSE driver of mainframe storage client 110. Once initialization completes, mainframe storage client 110 is ready to accept I/O requests for the given data source.
7. As files within the data source are accessed, various messages are sent from the application through mainframe storage client 110 and into the FUSE Driver of mainframe storage client 110. The Driver processes these messages as required by the specifics of the data source it supports, reading and writing data as necessary.
8. At some point, it may be desirable to “unmount” the filesystem, terminating access to the data source. This is basically the reverse of the flow above: the FUSE driver of mainframe storage client 110 is sent a shutdown message and when it terminates, the FUSE client of mainframe storage client 110 terminates and the PFS/VFS of mainframe storage client 110 cleans up.

Internally, once launched, a Driver of mainframe storage client 110 begins operation by registering an array of “callbacks” with the FUSE runtime library (LIBFUSE). In this context, a callback is a subroutine provided by the driver that handles a specific type of event or operation, such as reading or writing a file.

LIBFUSE fetches messages queued for the driver from the PFS/VFS of mainframe storage client 110 and calls the appropriate driver-provided callback routine based on the type of message. In this manner, the Driver mainframe storage client 110 is notified to process I/O requests and control functions as required.

A typical Driver of mainframe storage client 110 encapsulates the protocol needed to communicate with a particular data source. A “generic” Driver of mainframe storage client 110 that operates against a cloud service like Amazon S3 may work like this:
1. During initialization, register an array of callback functions with LIBFUSE, guaranteeing that the driver will be able to process the specific filesystem events it needs. Once initialized, LIBFUSE is given control, waiting for incoming messages and dispatching them to callback functions within the driver as messages arrive.
2. Typically, the driver includes functions to handle requests to mount the data source. In a typical driver, this would involve establishing a network connection to the data source (an Amazon S3 or Google Drive server, for instance). Often, credentials are required at this stage, so the driver would authenticate itself to the data source server and establish whatever encryption protocols are required (if any). Authentication and encryption protocols vary by data source provider, and the driver is expected to contain the logic for working with whatever data source is has been designed for.
3. One set of driver functions exist to process filesystem metadata, such as listing objects by name or providing attributes of particular data source objects. These functions typically trigger data source specific APIs to retrieve information from the data source server. For example, Amazon, Google and Dropbox all have different APIs to fetch metadata, and this logic would be encapsulated within the driver.
4. Another set of driver functions exist to handle data transfers, reading and writing data source objects as required. In addition to basic read and write functionality, most drivers include functions enabling file positioning (seeking), truncating files and so forth.
5. Another set of driver functions exist to perform control functions, such as deleting or renaming files, creating directories and so forth.
6. Another set of driver functions exist to handle termination and unmounting of the target data source. These functions clean up any network connections and other resources allocated by the driver and prepare for the PFS/VFS of mainframe storage client 110 to terminate the FUSE Client, the driver and any related resources.

In the case of physical storage devices connected via mainframe storage client 110, the approach generally follows the same flow as described above, except that most communication to the target device uses a single implementation of the iSCSI protocol. iSCSI is an industry standard defined by IETF RFC 3720 for communicating with storage devices over TCP/IP networks, and a single iSCSI FUSE driver can operate with storage devices from most vendors. See https://datatracker.ietf.org/doc/html/rfc3720 for details on iSCSI.

During operation, the FUSE Client of mainframe storage client 110 may override or supplement the processing normally performed by the mainframe storage client 110 Driver for the filesystem. An example would be applying data transformation policies to records as they are processed. Using data transformation policies defined to mainframe storage client 110, the FUSE Client can automatically transform records to and from any data source without specific code for transformations included in the Driver of mainframe storage client 110 itself.

Another example of functionality provided in the FUSE client of mainframe storage client 110 would be security processing. The FUSE Client of mainframe storage client 110 interfaces with the z/OS system security component to ensure that customers can use mainframe security policies to control access to all data source objects in a consistent manner. This is done outside the Driver of mainframe storage client 110 so that there's no need to implement this logic in every driver.

The mainframe storage client 110 implementation of the FUSE protocol also provides an additional set of library routines to all Drivers of mainframe storage client 110. These additional functions simplify access to several common z/OS-specific technologies within Drivers of mainframe storage client 110:
1. Encryption technology.
2. Security and auditing.
3. Cache control.
4. z/OS systems management functions, such as SMF recording.
5. Optimized networking functions.
6. Diagnostic aids.
7. Data transformation and character format translation

Mainframe environment 7 may comprise an IBM mainframe computer 11, upon which some or all of the applications/filesystems 9 may reside. However, in particular embodiments, mainframe environment 7 may comprise multiple mainframe computers. Mainframe 11 may be an IBM zSeries mainframe such as IBM z14, IBM z13, or IBM z13s or another mainframe device, and may include an operating system. In alternative embodiments, it may include another type(s) of mainframe computer(s) The operating system may be an IBM z/OS operating system or some other mainframe operating system. In a particular embodiment of the present disclosure, the mainframe computer may comprise a z/OS 2.4 on an IBM zPDT, operating at approximately 7-9 MSU running one or more general-purpose CPUs and at least one ZiiP processor (z Integrated Information Processor).

Mainframe 11 may contain applications such as SAS 9.4m5, SAS IT Resources Management, Enterprise Cobol for z/OS, Cobol V4, z/OS XL C/C++, Enterprise PL/I for z/OS, CA Cleanup, CA Easytrieve Report Generator, CA Endevor Software Change Manager, CA Librarian, CA MICS Resource Management, CA Optimizer, CA Optimizer/II, CA Panvalet, IBM Compiler and Library for REXX and Developer for z Systems, or any other applications suitable to execute a task.

The primary distinguishing characteristic of a mainframe is the operating system that runs the environment. Some of the more popular mainframe operating systems include z/OS, z/VM, z/VSE, z/Transaction Processing Facility and Linux. These mainframe operating systems are distinguished from the most popular non-mainframe operating systems such as Windows, OS X, IOS, Android, Linux, Unix. Other distinguishing characteristics of a mainframe environment include the file structure of the datasets and scalability (e.g., the ability to expand a single computer across a capacity range of over 1000:1 and to have tens of thousands of connected peripherals).

A mainframe environment is typically defined by a number of applications running on a mainframe operating system, with at least some and in some cases all of the applications sharing a particular dataset. In order to access the datasets, these applications rely upon at least one common file system and access method (VSAM, QSAM, BSAM, etc.) The mainframe environment of a particular enterprise typically refers to one or more mainframes, applications, shared storage, datasets and resources that comprise the environment leveraged by the enterprise. A particular mainframe environment may be defined by the mainframe resources behind a particular firewall set up by the enterprise. A mainframe environment may also be defined by a single, physical mainframe computer structure or the environment may include the resources within the organization (e.g., controlled by the organization, or behind the firewall of the organization).

The mainframe environment 7 of the present disclosure includes applications 120a-d being run by the enterprise. In a typical mainframe environment, many applications will run simultaneously. However, four applications (120a-d) are provided in FIG. 1 for illustrative purposes and to illustrate different types of applications and services.

Applications 120a-d rely upon dataset(s) 18 stored within the mainframe environment. The dataset(s) 18 may be arranged according to one or more of various data sets, including but not limited to a partitioned dataset (PDS), a portioned dataset extender (PDSE), VSAM key Sequenced Data Set (VSAM KSDS), VSAM Relative Record Data Set (VSAM RRDS), VSAM Entry-sequenced data set (VSAM ESDS), QSAM (Queued Sequential Access Method (QSAM), and/or UNIX Services Filesystems.

Multiple applications of applications 120a-d typically share particular data of dataset(s) 18 stored within the mainframe environment. Thus, applications within the mainframe environment become reliant upon dataset(s) 18, and cannot easily be removed from the mainframe environment and/or moved to another mainframe environment without dataset(s) 18.

In certain embodiments, mainframe environment 7 may represent one or more SYSPLEXes. A SYSPLEX is a group of distinct instances (images) of the mainframe operating system (i.e., z/OS). The mainframe operating system images could be running in separate physical computers, or they may be running in separate LPARs within a single computer, or they could be a combination of both. The z/OS instances participating within a SYSPLEX communicate using variety of different specialized communication components and hardware (e.g., XCF).

Non-mainframe environment 3 may include any number of environments running various operating systems, for example Microsoft Windows, Linux, VMware Unix. For example, cloud environments may comprise an Amazon Web Services, and/or Google Cloud environment. Cloud environment 30 includes enterprise business applications. In a typical cloud environment, many applications will run simultaneously.

The teachings of the present disclosure are intended to accommodate data sharing among the illustrated mainframe and cloud environments, even though the mainframe environment employs proprietary I/O systems. This allows for the proprietary I/O systems to access the “open” and “standards-based applications” of the cloud environment, and the “on premises storage applications (e.g., AF2).

Multiple applications within environment 30 may rely upon data 18′ in operation. However, given that cloud environment 30 is a “cloud” environment, all of the resources of cloud environment 30, including its applications and data 18′ may be distributed throughout the world in order to leverage the most cost effective, efficient and/or secure resources for accomplishing any given job, task, operation, workflow or transaction. A job is a separately executable unit of work and runs on the mainframe. This representation of a unit of work may consist of one task or multiple tasks. Each task may further consist of one step or multiple steps (transactions), where the execution of the step(s) may be required to complete a particular task of the multiple tasks.

In general, by “cloud” environment, it is meant to refer to the practice of using a network of remote servers (e.g., in some cases hosted on the internet) to store, manage, and process data, rather than a local server or a personal computer. In this manner, distributed resources around the globe (e.g., located outside of the firewall of the particular enterprise referred to above), may be leveraged to accomplish transactions previously intended for the mainframe environment.

As illustrated in FIG. 1, mainframe environment 7 may include one or more processors (CPUs) 22 capable of executing one or more executable instructions, and may also include one or more computer readable storage devices (e.g., memory) that may be volatile memory, non-volatile memory, or a combination of the two. Mainframe environment 7 may also include one or more input/output devices 26 (e.g., interfaces) to allow communication with other networks, such as network 5. The networks referenced herein may be Local Area Networks (LANs), Wireless Local Area Networks (WLANs), or a Wide Area Networks (WANs). Mainframe environment 7 may communicate with non-mainframe environment 3 using appropriate communication protocols (e.g., TCP/IP).

FIG. 8 illustrates a method 800 for executing an I/O Request in accordance with a particular embodiment of the present disclosure. The method begins at step 802 where an input/output (I/O) request is received at a storage client, from a mainframe application. The input/output (I/O) request may be received pursuant to a first protocol that is a proprietary, mainframe protocol. The storage client may include a plurality of drivers, each driver being associated with a respective one of a plurality of data sources.

At step 804 a first one of the plurality of data sources that is suitable for addressing the I/O request is identified. The first one of the plurality of data sources may be configured to communicate using a second protocol. Moreover, the second protocol may be a standards-based I/O protocol that is inconsistent with the first protocol. At step 806, configuration data associated with the respective driver of the identified data source is accessed. The configuration data may be specific to the particular data source and allow for communication with the particular data source to understand how to receive data and the format of the data.

At step 808, the I/O request is converted to a specific capability of the data source. The capability may be in accordance with the second protocol of the data source.

At step 810, security and management policies associated with the mainframe application may be enforced, using the storage client. Similarly, security and management policies associated with the identified data source may be enforced, using the storage client.

Next, at step 812, the I/O request is executed on the identified data source, using the corresponding capability pursuant to the second protocol. At step 814, data is received from the data source, in response to executing the I/O request on the identified data source.

In response to the I/O request, data is received from the identified data source, at step 814. At step 816 a determination is made whether the data received from the identified data source requires transformation in order to be consistent with the first protocol, or not. If the data does require transformation, the data is transformed at step 818. If the determination is made at step 816 that the data does not require transformation, the method continues to step 820, where the data (transformed if determined necessary, not transformed if not necessary) is communicated to the mainframe in response to the I/O request.

Most enterprises today (including approximately 8,000 mainframe customers) are looking to move their IT operations to the cloud for cost savings and to enable the modernization of their IT infrastructure, and to allow for growth. However, given most technology available today, converting from mainframe environment 10 to cloud environment 30 for even a moderately sized enterprise is a high-risk, high-dollar endeavor that may take large teams of people multiple years to accomplish. When a network of inter-connected applications and data can be spun-off and moved to the cloud one at a time, tracking their dependencies can be daunting, and it may turn out to be too entangled to proceed with a safe migration. The risk involved is loss of data, loss of functionality of the cloud environment or services it provides, crashing of applications, inoperability of applications within the environment or corruption of data. Since enterprises that have access to mainframe environments typically put the most critical functions in the mainframe environment, the culmination of any such risks can be devastating to the enterprise.

As an example of the time, cost and complexity of such an effort, Amazon Web Services published an example of the manner in which the New York Times accomplished mainframe to AWS cloud migration, in a blog in May, 2019 (see, ttps://aws.amazon.com/blogs/apn/automated-refactoring-of-a-new-york-times-mainframe-to-aws-with-modern-systems). The process involved an eight step process that occurred over a period of five years, in order to transform a single legacy COBOL-based application into a modern Java-based application.

The process is illustrated below (excerpted from the above referenced blog post):

Whether the goal of an organization is to convert entirely from the mainframe environment to the cloud environment, or only convert certain applications, features, functions, workloads, etc. (e.g., data storage) to the cloud based environment, the teachings of the present disclosure allow this to be accomplished in a way that avoids the time, expense and risk of an all or nothing approach. Such teachings also allow for the migration of one or more features or functions (e.g., data storage) in much less time, and with much less risk, by allowing the mainframe environment and the cloud environment to run simultaneously, relying upon and continuously updating a common data among the mainframe environment and the cloud environment.

For example, any particular large airline may never want to move its ticketing system to the cloud, since ticketing systems of large airlines may always require the power of a mainframe. So given today's technology, such an airline would not be candidate for mainframe to cloud migration for any of its computing resources. However, given the teachings of the present disclosure, such an airline could leave its ticketing system on the mainframe, but migrate other features or functions (e.g., data storage) that are interconnected with the ticketing system to a cloud environment in order to see significant cost savings.

Each of computer or server referenced herein may include one or more processors (CPUs) capable of executing one or more executable instructions, as well as one or more computer readable storage devices (e.g., memory) that may be volatile memory, non-volatile memory, or a combination of the two. Each may also include one or more input/output devices and/or interfaces.

In accordance with particular embodiments, any access to the mainframe environment 7 may be done in a secure manner. For example, it may be possible to specify a security identity when attaching a mainframe file share to a remote system, and then all z/OS file access for that share will reference that particular user. Thus, security checking will leverage the customer's security product (e.g., CA ACF2, CA Top Secret, or IBM RACF) and any other mainframe security policies that the enterprise defines.

In alternative embodiments, remote access may trigger “normal” mainframe management instrumentation, meaning that files can be automatically archived/recalled, audited, monitored for performance, etc.

In accordance with particular embodiments, network flows may follow industry-standard network file sharing protocols (e.g., NFS V4), with the benefit that little to no data-sharing software will be required on the “client” side (i.e., the cloud environment) when accessing basic mainframe data. Basic access to mainframe data may be configured to work from any system having an appropriate NFS client, including Windows, Linux and other platforms.

Thus, the teachings of the present disclosure can be used to make a broad collection of datasets of the non-mainframe environment 3 accessible from applications running in a mainframe environment, and vice versa (e.g., datasets of a mainframe environment accessible by the cloud environment, including sequential (QSAM/BSAM), partitioned (PDS/PDSE) and VSAM datasets. Moreover, the teachings of the present disclosure include the ability to randomly process records within a VSAM dataset (e.g., search a VSAM file for a record matching a particular key or relative record number, and then read just that single record). The teachings will also include the ability to access those records sequentially (for example, if a keyed VSAM KSDS is accessed, read the dataset in sequential order—i.e., order of ascending keys since the file is a VSAM KSDS).

The teachings of the present disclosure provide advanced capabilities for data sharing among mainframe and non-mainframe environments. Some of these capabilities are set forth below:
Navigate files in multiple directions (forward to backward, or backward to forward).
Read records by record number (“get the 423rd record”).
Insert records anywhere in a file without rewriting it.
Delete records from anywhere in a file without rewriting it.
Update (re-write) individual records in place.
Perform updates or so-called “repeatable reads” with transactional integrity.
Process so-called alternate indexes where multiple search keys may be available for a given search argument.
Create files containing data to be printed on the target system.
Alter the structure of existing files, or create new files in proprietary formats.
Obtain comprehensive metadata for files on the server.
Participate in single- or multi-resource transactions, including the ability to COMMIT or ROLLBACK changes.

### Transactional Virtualization

Transactional virtualization is discussed in detail in U.S. patent application Ser. No. 16/680,963 and entitled “System and Method for Enhancing the Efficiency of Mainframe Operations,” which is hereby incorporated by reference. Consistent with the teachings of the present disclosure, it is clear that the target of any transactional virtualization can be anywhere, including to platforms different from the originating source platform. However, a more robust definition of the target execution environment is required. For example, if a mainframe binary executable is taken to a Windows computer, an interpretive layer needs to be in place so that the mainframe executable can somehow be run on a computing architecture that's not native to it. At the other end of the spectrum, a Java program can generally run anywhere-there's no need for an extra layer of interpretation or emulation there. Thus, the approach to implement the teachings of the present disclosure will vary, depending on the nature of the application involved and the differences between the original source and the target.

Organizations' valuable data is stored in a variety of ways today: in the cloud, on SAN devices, or in SaaS applications, to name a few. The mainframe has not really participated in this approach. However, the teachings of the present invention includes features and functions that allow a mainframe storage client (“MSC”), as described above, to expand the participation of the mainframe in data storage. For example, in particular embodiments, the MSC operates under a concept of “IBM Z as the client.” This approach “elevates” the mainframe so that it has the same capabilities as other platforms when it comes to accessing data.

For example, applications running on IBM Z can get real-time, read-write access to data on storage platforms such as Amazon S3 and/or created by applications running in the cloud or on distributed platforms (GitHub or http://Salesforce.com, for example). MSC makes a broad universe of data sources newly available to mainframe applications that can consume that data any in any way it chooses—without losing any of the mainframe's classic strengths, like security and policies.

Use cases of particular embodiments of the present disclosure are discussed below, and are intended to be non-limiting, but illustrative of various embodiments.

### Cloud/Distributed Applications

There are many use cases for enabling mainframe applications to access data from cloud and distributed applications. MSC may allow this to be done directly and without intermediaries or extra manual effort.
A user has a COBOL business application running on z/OS that needs to read and write data in the Amazon S3 cloud. With MSC, a JCL change allows for that.
A user is generating data in a SaaS application like Workday that they need to process in their mainframe application. With MSC, it is simple and straightforward to configure for that.
A user is using GitHub as their enterprise source code repository, but they tend to have different solutions for their mainframe code, because it is not as easy to connect to GitHub. They are likely to still be using some legacy source code management system, like Panvalet or Librarian. With MSC, they can create a direct connection to GitHub. All those files then look just like local files to their z/OS applications. For example, mainframe applications which are compiling various programs that need access to the corporate source code libraries can directly do that against sources like GitHub, without having an ETL type process or the need to move that data back and forth.

### Connected Storage

There are many valuable use cases for enabling mainframe applications to access data from connected storage devices.
One of the core use cases for MSC is connecting the mainframe to a whole family of storage devices using the iSCSI protocol (or any network protocol). Users may find it advantageous to use lower-cost, high-performance storage from vendors like NetApp, Quantum, Dell, and others.
With MSC, a user can access file systems on any type of device through network protocols like iSCSI and others. This gives mainframe users entirely new options for the type of devices they can connect to their mainframe.

### Access Multiple Data Sources Concurrently

MSC enables applications to access multiple data sources in parallel within a single application. Here are a few examples:
An application reads records from Amazon S3 storage and writes to Dropbox.
A user can write a file to OneDrive and archive a copy of that same data in Azure.
A user can do both of those concurrently within a single application, with a broad mix of data sources.

Historically, the most common way for mainframe applications to consume non-mainframe data is through custom code. This approach can be expensive, time consuming, error prone, and requires ongoing maintenance. For example, a user might write specific software to connect their mainframe application to storage platforms like Dropbox or Amazon S3. This is less than optimal for several reasons: (i) it might not be a lot of code, but it can be complicated and expensive to maintain over time. (ii) most large organizations will need to create many instances of this—they might have Dropbox and Amazon S3, or they might have OneDrive and Google Drive, and they will need to write and maintain code for each. Further, the only applications that they can really connect this way are going to be custom applications that are coded to read and write data from the possibly multiple target data sources. Finally, storage platforms are changing all the time, so the code written three years ago to access files in Amazon S3, for example, likely won't work the same way today.

There are related technologies like JDBC. A user can have a JDBC application running on z/OS that connects to Microsoft SQL server (or any database running on any platform that has a JDBC implementation available for it). But it is a small universe of applications that fit that scenario. Hardware devices are another possibility. Lower-cost storage devices can be connected to the mainframe using a hardware solution that talks iSCSI protocols or FCP protocols and can connect to a mainframe IO channel, so the device looks like a mainframe device.

The approach of the MSC of the present disclosure is very different. It allows for multiple data sources and does it in a way that can be zero new code, where any application that can reference local files can work against the cloud (including applications that are connecting to local, low-cost storage devices residing in the customer's own data center).

### Built on Open Standards

At its lower levels, MSC is based on open source and industry standards. It includes a robust installable device driver architecture that makes it easy to integrate a multitude of data sources with MSC, including popular cloud storage systems like Amazon S3, Google Drive, Microsoft OneDrive, Dropbox, and many others. The device driver architecture is based on open standards, making many implementations immediately available to MSC users by simply reusing existing software. The MSC leverages proven, existing device drivers that are in common use on other platforms (versus building our own) and run them on z/OS. As an example, Windows users often have more devices they plug into their Windows computers than Linux users do. With MSC's standards-based approach, the Linux user can use anything that is been developed for the Microsoft world on their platform.

### iSCSI Support

MSC's device driver architecture also supports technologies such as the iSCSI standard—a popular protocol that enables high-performance, low-cost storage devices to be accessed over a TCP/IP network. Built-in support for the iSCSI standard enables storage devices from a variety of vendors (NetApp or Dell, for example) to easily be connected to mainframes and accessed by many mainframe applications. The iSCSI protocol is very high performance. It is universally supported across a wide range of hardware devices, giving MSC the ability to connect to SANs and all sorts of different devices from z/OS. Additionally, because iSCSI is a network protocol, the only hardware a user needs is a TCP/IP network connection. There is nothing physically that you are connecting to a mainframe channel. It is accomplished over a network channel.

### Support for Cloud and SaaS

With MSC, cloud applications and SaaS services can be consumed by mainframe applications. The popular open-source GIT source code management system, for example, can be accessed by mainframe DevOps tools as an alternative to retaining source code and other artifacts solely on the mainframe. In this example, MSC is not just reading and writing discs in GitHub; it is communicating with the GitHub service, providing access to the underlying data and then making that appear like ordinary files to the mainframe applications. This same concept applies to a broad range of cloud and Saas offerings, including Workday, http://Salesforce.com, email systems, and many others.

### Concurrent Data Access

With MSC, a single application can access multiple data sources concurrently. For example, an application can be used to read records from Amazon S3 storage, write to Dropbox, and write copies to Azure. This opens a whole range of new ideas for things like fault tolerance. For example, instead of writing data only to Amazon S3, a user can write copies to Google Drive, OneDrive, and Azure. The cost of these storage systems is so low that the user can afford to do that and still save money (versus keeping it stored on the mainframe). This provides the added flexibility to make decisions practically in real-time, on the fly for cost and performance reasons. For example, if an application needs to create a hundred terabytes of information on a given day, where is the cheapest place to put that? One day the cheapest place to put that could be Azure, while the next it might be Amazon and the day after it might be Google. With MSC, a user can adapt and adjust your targets (storage applications) based on cost and performance.

### Bidirectional and Automatic Data Transformation

One of the built-in capabilities in MSC is that data can be transformed bidirectionally (incoming and outgoing). Non-mainframe data can automatically be transformed into a format that can be processed by mainframe applications and vice versa. For example, MSC enables an Excel spreadsheet stored in OneDrive to be directly processed by a mainframe application. Automatic data transformation enables the records of that spreadsheet to be transformed from UTF-8 text encoding to a text format that is readable to most mainframe applications. Another example is a large, Complicated mainframe data record that is transformed to a CSV file that can be processed in Microsoft Excel. This transformation happens dynamically and with great flexibility. If a user has two different applications running on a mainframe, one application can see data transformed a certain way, while the other application sees the same data transformed completely differently.

### Security

MSC works in conjunction with mainframe security software and policies to control exactly what data any user or application can reference, providing integrated authentication, authorization checking, data privacy enforcement, and auditing support. In parallel, MSC also supports the security protocols implemented by the storage provider, managing credentials, encryption and so forth as required. As an example, a site connecting to Amazon S3 would use Amazon credentials to control what Amazon S3 storage resources a particular mainframe system is able to access, while mainframe security policies limit the resources a particular mainframe user can access. With the “IBM Z as a client” approach described above, mainframes are potentially going to be talking to a lot of different cloud data sources, and each of those might have a lot of different user accounts. MSC lets you manage those different client connections at the same time, using different credentials on each of them. You decide what credentials you want to use when connecting to the cloud data source, and then you use mainframe style security policies to control who can access that.

### Data Integrity

Data integrity varies depending on the capabilities of the cloud provider. Many cloud providers implement systems where it is essentially a single application at a time. Amazon S3, for instance, can have policies where a user can have as many readers as you want, but only one application can write the file at a time. This ensures integrity by guaranteeing you cannot have multiple updaters against the file running in parallel. If you use MSC in a model that allows for “multiple readers, single writer,” those are the rules MSC implements and follows.

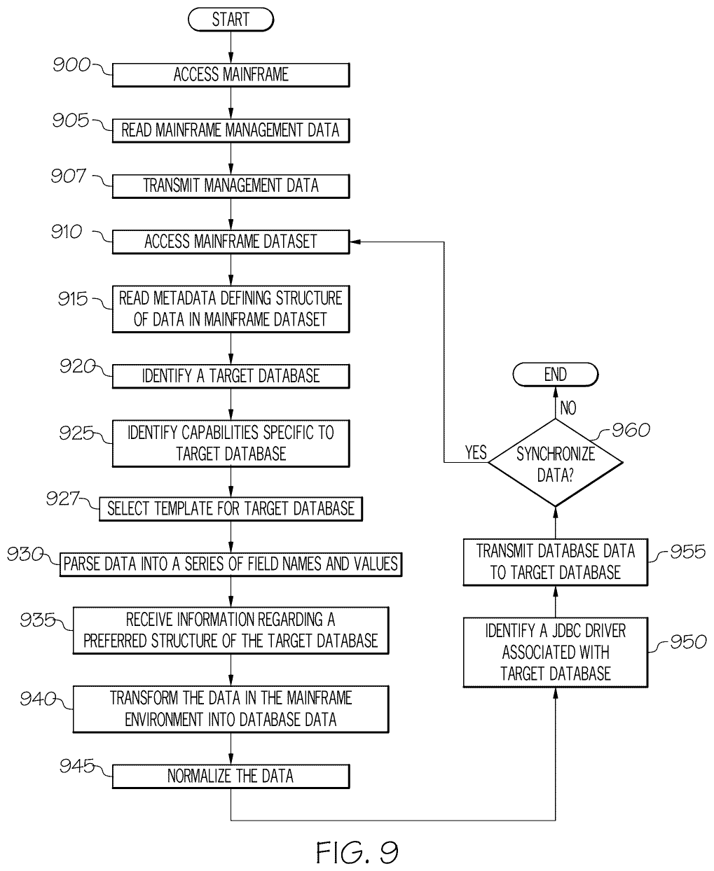

In accordance with other aspects of the present disclosure, a mainframe dataset may be transformed and transmitted to a non-mainframe environment. For example, FIG. 9 illustrates an example method for mainframe data monitoring and transformation, in accordance with particular embodiments of the disclosure. The method begins at step 900 where a mainframe is accessed. In particular embodiments, management data of the mainframe may be read from the mainframe environment, and may be accomplished in real time, at step 905. Reading management data from the mainframe in real time allows for the distribution of the mainframe management data to another platform (step 907) which may be a non-mainframe environment. This distribution may be done in real time to allow users with faster access to mainframe management data (e.g., error message, intrusion detection, failures, etc.). In other embodiments, the management data may be collected, stored and/or batched at the mainframe for later distribution to the other platform (at predetermined intervals, or upon the occurrence of a specific message or specific type of message, upon request from the user, and/or upon reaching a threshold amount of management data to be transmitted).

At step 910 where a mainframe dataset within a mainframe environment is accessed. A dataset is a collection of related data that is typically organized in a structured format. It is a fundamental unit in data analysis, storage, and processing, and can be found in many fields like statistics, machine learning, database management, and data science. A dataset can be defined in several contexts, and its specific meaning depends on the environment in which it is used.

In particular embodiments, the initial dataset may include some combination of mainframe data (e.g., mainframe dataset) and data from a non-mainframe environment (e.g., relational database). In this case, the data may be combined within the mainframe environment and then transformed into a format which the target database can receive and further process.

In the context of mainframe systems, a dataset may comprise a collection of data stored in files. Mainframe datasets are typically stored on Direct Access Storage Devices (DASD) or tape drives, and they are often organized in a specific structure, like VSAM (Virtual Storage Access Method) files, sequential files, or partitioned datasets. A Sequential Dataset comprises data stored in a simple, sequential format, where records are written and read one after another. A Partitioned Dataset (PDS) is a mainframe dataset that contains multiple members (files), each with its own data, such as source code files or configuration files. An indexed Dataset is a dataset where records are indexed for faster access, allowing both sequential and direct access.

Mainframe datasets are distinguished from datasets in non-mainframe environments, such as databases. In the context of databases (e.g., relational databases), a dataset often refers to a table or a result set that contains data in rows and columns. For example, in a relational database, a table is a collection of rows (records) and columns (fields) that store related data. For example, a table named employees might have columns like employee_id, first_name, last_name, hire_date, etc. The entire table is considered a dataset. A dataset can also refer to the set of results returned from a query or a SELECT statement in a database. For example, if you query a database for all employees hired after Jan. 1, 2020, the result of that query would be a result set or dataset containing those employees. Mainframe datasets are often considered “unstructured” since they lack the “table/row/column structure” of many databases.

A VSAM dataset, for example, includes no metadata within the data set. Instead, the structure of the mainframe data is described by external artifacts that are stored elsewhere. For example, cobol copybooks or another catalog may be used to describe the structure of data within a mainframe dataset such as a VSAM dataset. These external artifacts may be referred to as metadata, but these external artifacts are not included in the mainframe dataset in the way that structured databases (e.g., relational databases) embed the metadata within the file.

In particular embodiments, the initial dataset may include some combination of mainframe data (e.g., mainframe dataset) and data from a non-mainframe environment (e.g., relational database). In this case, the data may be combined within the mainframe environment and then transformed into a format which the target database can receive and further process. For example, a mainframe dataset may be combined with data from a database in a first format, transformed and transmitted to another database that requires data in a second format that is incompatible with the first format.

At step 915, metadata defining the structure of the data in the mainframe dataset is read. The metadata describing the structure of the data within the dataset allows for sufficient understanding of the structure to allow the data to be parsed and transformed, into a structure that is useable outside of the mainframe environment. The transformation also takes into account any indexing necessary for the database to understand the data. The transformation can also include automatically identifying any data integrity rules that the database abides by (e.g., a null value cannot be inserted into a particular row or column) and supplement with data that will allow the database to receive the data without error. In another example, the teachings disclosed herein may provide default values (e.g., if no data is provided that is being placed into a date field, the transformation may include automatically applying a current time stamp so that the field does not remain blank.

In particular embodiments, the metadata defining the structure of the data may be read from a catalog as referred to above. For example, the catalog may be a COBOL Copybook. A COBOL Copybook is a text file or template in COBOL programming that defines the structure of data for use in multiple programs or sections of code. It is commonly used to define data record formats in COBOL applications, especially when dealing with file processing, data interchange, or integration between different systems. The copybook typically contains definitions of data items, data structures, and records that are used to ensure consistent formatting and handling of data across different parts of the program. It is called a “copybook” because it is essentially a reusable code fragment that can be “copied” (included) into various programs or data divisions.

A COBOL copybook is designed to be reusable across multiple programs (e.g., template based). This means that instead of defining the same structure multiple times in different places, a programmer can create a single copybook and include it wherever needed. Copybooks typically contain data structure definitions like arrays, records, and fields that represent data records or messages exchanged between systems. These structures are defined in a hierarchical way (i.e., with subgroups, levels, and data types). A common use of a COBOL copybook is to define the layout of a file or record. For example, a copybook might define a record format for an input or output file that contains multiple fields such as customer name, address, phone number, etc. In COBOL programs, copybooks are included using the COPY statement. The COPY statement is used to insert the content of the copybook into the COBOL program at compile-time, allowing the program to reference the predefined data structures or record layouts.

In COBOL, data items in the copybook can be defined with specific data types, such as PIC X (alphanumeric), PIC 9 (numeric), PIC 99 (2-digit numeric), or PIC X(10) (a 10-character alphanumeric field), among others. The level numbers in the copybook define the hierarchy or relationship between fields. For example, a 01 level defines a record or group item, and 05 or 10 levels define individual fields or sub-items within the group.

Copybooks are often used in file processing, especially when dealing with files that contain structured records (such as flat files). For example, a copybook might define the structure of each line in a flat file, and the COBOL program would use the copybook to read or write that data. Copybooks are also used to ensure consistency when data is exchanged between different systems. For example, a COBOL application might use a copybook to define the format of records in a file that is being exchanged with another system, and this format must be consistent on both sides. This is helpful, in the context of the teachings within this specification, since the copybook includes specific information about the format of the data within the mainframe dataset. Such information allows for the transformation to a format that is readable outside of the mainframe environment (e.g., cloud environment).

In some cases, copybooks are used to define the structure of database records, especially when working with mainframe databases like IMS or DB2. The copybook can be used to ensure that records are properly structured when read from or written to the database. Thus, in COBOL, a copybook is a template or reusable definition that simplifies the management and handling of data structures. It is especially useful for defining complex record layouts that need to be used across multiple programs or systems. By allowing code reuse and promoting consistency, copybooks help reduce errors and simplify the maintenance of COBOL applications, particularly when dealing with data files and records in legacy systems.

In certain embodiments, the metadata that defines the structure of the data within the mainframe dataset is provided by the user of the mainframe (e.g., customer). Since unstructured files within the mainframe dataset don't include embedded metadata (information about the structure of the data within the mainframe dataset), this information must be received in order to accomplish the data transformations sufficient to transmit the data to a database in a structure that the database can understand. The unstructured data from the mainframe dataset must be normalized in order to fit within the structure of rows and columns of the database, in a way that allows the data to be used by the database. Transformation of the data is a function of both the format/structure of the database data and nuances of the target database (need to understand the capabilities of the target database).

The teachings disclosed herein allow for the automatic detection of the type and structure of the data within the mainframe dataset. For example, the data from the mainframe dataset is read, then parsed, then it is determined the type and structure of the data, and then the data from the mainframe dataset is ready to be transformed to a format usable by a non-mainframe environment (e.g., relational database). For example, SQL databases only support a certain number and type of queries. Thus, in many instances, the data of the mainframe dataset has a structure that cannot be received by a database (e.g. SQL database). The teachings disclosed herein allow for automatic and dynamic restructuring of data from the dataset into a format that can be received by the database. For example, mainframe data may be formatted in a way that the database cannot receive or interpret. Time stamps of mainframe data can sometime measure to the nanosecond and databases do not offer that level of precision and cannot receive a cell of that size. In order to allow the data to be conserved and delivered to the database, the data is automatically identified as a type not supported by the database and dynamically restructured into a format that the database can interpret. In the example of the timestamp, the teachings herein create a separate table that stores the time stamp information so that it can be accessed by the database. In some embodiments, the table is created such that it can be joinable to the database such that the precise timestamp data can be retained.

Next, at step 920, a target database is selected. The target database is typically the database to which a user would like to transfer data from within the mainframe dataset. In some embodiments, the target database may exist outside of the mainframe environment. This is helpful for users that intend to transfer data out of a mainframe for use in a non-mainframe environment (e.g., cloud). The target database may be selected from a plurality of available databases, for example, a plurality of databases within a particular enterprise. The selection of the target database may be based at least in part on capabilities specific to the database, and/or capabilities desirable to manage the data to be transformed and transmitted from the mainframe environment.

In particular embodiments, capabilities that are specific to the selected database are identified at step 925. Understanding the capabilities of the target database provides pertinent information to confirm that the target database can handle the specific task, and also provides an understanding of the specific transformation that must be done to the data of the mainframe dataset in order for the data to be usable after it is transmitted to the target database.

Understanding the capabilities of the target database can play an important role in data transformation. For example, databases may be limited as to the data types it will interpret. In mainframe environment, there are multiple ways to express an integer value. It can be important to understand how many decimal points the database can handle, floating point numbers, particular size of integer value, number of decimal places, etc. The teachings disclosed herein allow for an understanding of the capability of the database (data types available to the database) and will automatically and dynamically select the closest (most appropriate) to the mainframe data structure to perform the transformation.

Mainframe data is indexed using a record key. In certain embodiments, data that is received with a certain key value can be converted in order to understand which multiple columns correspond in the database.

The capabilities of the target database may also assist or determine the manner in which transformed data is transmitted to the target databased. For example, the transformed data from a specific job (transforming data of a mainframe dataset to a format suitable for a database) may be transmitted to the target database in batches, as opposed to all at once. This may be determined with reference to the ability of the database to receive data and/or the quantity of data that can be received and loaded over time. Thus, determining the capability of the database to receive data may be automatically determined on the mainframe software, and then the “output” of the data transformation may be automatically broken into batches based upon the determined capabilities. For example, understanding how many rows a database can most efficiently process may determine the size of batches that are assembled on the mainframe in a journaled area of the database before being transmitted to the database. In this manner, the output of one “job” may be broken down into multiple batches for synchronous (or asynchronous) transmission to the target database.

Since many different databases use slightly different “dialects” of SQL (different methods to communicate with SQL based databases), the teachings disclosed herein employ a template approach depending upon the type of target database to be communicated with. Thus, at step 927, the method selects a particular template to use to transform the mainframe dataset to a database recognizable by the target database. The template selected determines the specific queries to be used in the data transformation. For example, for an X database that employs a certain dialect of SQL, specific queries will be used in the data transformation.

The templates are used to define the syntax necessary for the particular target database to understand the data being received. In certain embodiments, a user or customer can select or define a template for a particular conversion. For example, a certain user may want to add a time stamp to the database each time a new row (or column) is added to the database.

At step 930, data within the mainframe dataset is parsed into a series of field names and values. Information gleaned from the metadata of the catalog can be used in accomplishing this step. Parsing the data in this way allows for the transformation of the data into a structure and format which can be understood and incorporated into a non-mainframe environment (e.g., a database in the cloud). Parsing of the data of the mainframe dataset may be accomplished within the mainframe environment. For example, the hardware and software used to accomplish the parsing may reside on the mainframe that stores some or all of the mainframe dataset, or may otherwise exist within the mainframe environment (e.g., resident upon a mainframe server other than the mainframe server that houses some or all of the mainframe dataset.

In particular embodiments, information regarding a preferred structure of the target database may be received at step 935. This information may be provided by a third party (e.g., the enterprise in which the target database resides and/or in which the transformed data may be utilized). This information may be used in the transformation of the data in order to confirm that it is organized in a format most useful to the end user(s) (e.g., user(s) running the target database). In the absence of receiving information regarding the preferred structure of the target database, information regarding the capabilities of the target database alone may be used to determine or select the structure of the target database. Examples of information regarding the preferred structure of the target database may include determine how integers may be transformed to binary, double precision floating point transformed to binary, varchar (character data) or Unicode transformed to UTF8, floating point into longitude/latitude, etc.

For example, the above allows for the creation of indexes on certain fields (rows/columns) within the database based upon predetermined desire of an end user or customer. There are many ways to create an index in a relational database so having the predetermined desire of the end user or customer and knowing in advance how the end user or customer wants to use the data allows for creation of specific indexes on specific fields, during the data transformation process.

At step 940, the data in the mainframe environment is transformed into database data. In other words, data from the mainframe environment, which is “unstructured” (lack the “table/row/column structure of a database) is transformed into a structure that the database can read and allow for manipulation of the data within the database. In particular embodiments, this transformation may take place within the mainframe environment, since the hardware that enables this transformation may be located within the mainframe that houses the mainframe data, or another server (e.g., mainframe) within the mainframe environment. In other attempts to transform mainframe data into database data, the transformation required the data to be exported from the mainframe before the transformation could take place.

Transforming mainframe data into database data used to involve extracting the data in bulk from the mainframe, transforming it into a suitable format, and then loading it into a modern relational database or other types of databases. The process was referred to as ETL (Extract, Transform, Load). Since mainframe systems often store data in legacy formats such as VSAM (Virtual Storage Access Method), DB2, or flat files (e.g., sequential or fixed-width files), in the past these files needed to be extracted for further processing. Several tools or methods have been used. For example, Mainframe File Transfer Protocols (tools like FTP (File Transfer Protocol)) were used to copy files from the mainframe system to a staging area (local or cloud-based). In other systems, custom extraction scripts were written (e.g., COBOL programs, REXX scripts) in order to extract and transform data from mainframe systems. In particular embodiments of techniques described within this specification, for a mainframe that uses DB2 or other databases, connectors (JDBC, ODBC, or other connectors) are used to connect to the mainframe data.

The transformation step may involve cleaning, normalizing, and/or converting the data into a format suitable for the target database. This can include: (i) data cleansing to insure the data is consistent and accurate, removing duplicates, correcting errors, and handling missing or incomplete values; (ii) converting legacy data formats (e.g., EBCDIC encoding, fixed-width records) into standard formats like UTF-8 or CSV, which are compatible with modern relational databases; (iii) mapping the mainframe data fields to corresponding fields in the new database schema (e.g., a fixed-width field in a mainframe file may be split into several smaller fields in a relational database; (iv) normalizing the data (if the data is denormalized (i.e., not in a normalized relational form)) normalization may be required to normalize it to reduce redundancy; and/or (v) enrich, enhance and/or augment the data with additional information during transformation (e.g., by adding reference data from external sources).

Various tools are available to assist in transformation. For example, ETL tools (Apache Nifi, Talend, Informatica, Microsoft SSIS), scripting languages (Python, Java, or custom scripts for specific data transformations).

As noted above, transformation often includes normalization at step 945 in which the data is normalized. Normalization helps ensure data consistency, reduces redundancy, and makes the database more flexible for queries and updates. It includes the process of organizing and structuring data to minimize redundancy and dependency by dividing it into related tables and ensuring that each table focuses on a specific aspect of the data. The goal is to make the database more efficient and flexible, while reducing data anomalies and maintaining data integrity. Normalization typically involves applying a set of rules (called normal forms) to break down the data into smaller, logically structured tables. Each level of normalization, or normal form, builds upon the previous one.

In particular embodiments, at JDBC driver may be used to connect to the target database. Thus, at step 950, a JDBC driver that is associated with the particular target database is identified. A Java Database Connectivity (JDBC) driver is a software component that enables a Java application to interact with a database. It provides a means for Java programs to send SQL queries to a database, retrieve data, and update the database. JDBC drivers act as intermediaries between the Java application and the database, translating Java calls into database-specific calls and vice versa. In simpler terms, a JDBC driver allows Java applications to connect to and communicate with a relational database by implementing the JDBC API.

A JDBC driver may be used to help establish a connection to the database by using the provided connection URL, username, and password. The driver also allows the Java application to execute SQL queries and commands against the database (e.g., SELECT, INSERT, UPDATE, DELETE). The driver may be used to retrieve the results from database queries and process them in a format that Java can use (usually as ResultSets). The JDBC driver may also translate any database errors into exceptions that Java can handle (e.g., SQLException). It is important to note that the correct JDBC driver must be used in the classpath for a particular Java application, since different databases require different JDBC drivers. JDBC drivers are also database-specific to the type of database being used (e.g., MySQL, Oracle, PostgreSQL, etc.). The JDBC driver, in particular embodiments, resides upon the mainframe server (or otherwise within the mainframe environment.

The teachings of the present disclosure also allow for transformation of mainframe datasets that include arrays. An array in a database refers to a data type or structure that stores multiple values in a single column or field. Arrays allow for the storage of multiple related items (e.g., a list of values, a collection of objects, or multiple measurements) in one record, which can be more efficient than storing each item as a separate row. Arrays are often used when the number of elements is fixed or manageable and when the elements share a logical relationship, such as storing multiple phone numbers for a user or multiple products in an order. Different types of databases handle arrays differently. For example, relational databases like MySQL, PostgreSQL, and Oracle don't natively support arrays. Thus, in order to “normalize” the array when transforming a mainframe dataset to a non-mainframe environment (e.g., MySQL database) the teaching disclosed herein place the data of the array into separate tables. Although MySQL does not have built-in support for arrays as a data type, the teachings herein allow a user to simulate an array by normalizing the data and store multiple related values in separate tables/columns/rows. In another embodiment a JSON field (for MySQL 5.7+) may be used. Thus, in accordance with the teachings of the present disclosure, the array is normalized (mainframe dataset is broken down into one row for every set of values) and multiple tables.

During data transformation, when an array is detected, multiple tables and subtables are created. For example, repeating fields are extracted from the mainframe data, and tables and relationships are created during the data transformation process. This allows the array(s) from the mainframe dataset to be transformed into a structure (table, columns, rows) that may be understood by the database in the non-mainframe environment.

The teachings of the present disclosure also allow for the transformation of a collection of data that includes a mainframe dataset and a data set from a non-mainframe environment (e.g., data from a MySQL database). One way to accomplish this is to join the data together within the mainframe enviroment and arrange the mix of data into a single structure that can be transmitted to and read into a single target database.

In the past, in order to move data from a mainframe dataset to a non-mainframe database, the mainframe dataset would be removed from the mainframe environment and onto another platform (non-mainframe environment) where the data would be processed and then moved to the target database. The teachings of this disclosure allow for data from the mainframe dataset to be moved directly from the mainframe environment to the target database, since the software that performs the features and functions described herein may be resident on the mainframe that holds the dataset, or elsewhere within the mainframe environment (e.g., resident on another mainframe server). As discussed further herein, the same thing can be accomplished with management data as opposed to data files. For example, management data may include internet files, operating system files, statistics, security events, etc. (thus, not “files” but management data).

The teachings of the present disclosure allow for management data to be automatically collected in real time and transformed into database data suitable for a non-mainframe environment. This can be helpful for management data (as opposed to data files) that are important to receive timely, and can be transformed into a format suitable for storage in a non-mainframe environment. For example, banks are required to store management data (e.g., security events within the mainframe, intrusion detection, failures, etc.) for long periods of time which is very expensive in a mainframe environment. There is significant cost savings to storing this information in a low cost database and also allows for low cost replication of the data so that it can be stored in multiple locations for backup.

In the context of a mainframe, management data refers to the information that is used to monitor, control, and optimize the performance and operation of the mainframe system and its components. This data is crucial for system administrators and operators to ensure the mainframe is running efficiently and to troubleshoot any issues that might arise. System performance data includes information like CPU Usage (the amount of processing power used by different tasks, workloads, or users), memory usage (information about system memory (RAM) consumption, swap space, and paging activity), disk usage (details on storage utilization, including disk space availability, I/O activity, and read/write operations) and network traffic (data related to the flow of information in and out of the system, including throughput and latency). Job and Task Management Data includes job queues (information about jobs waiting to be processed, their status, and priority), job execution data (information about job completion, processing times, job steps, and any errors or issues that occurred during execution) and resource allocation (tracks how system resources (CPU, memory, I/O) are being allocated and used by different jobs or tasks). System health data includes error Logs (logs that capture system errors, crashes, and hardware failures), warning messages (notifications about potential issues, such as low disk space or high CPU usage) and system alerts (real-time alerts or alarms that signal abnormal system conditions, like failures or performance bottlenecks). Security and Access Management Data includes user access logs (information on who is accessing the system, when, and what resources are being accessed), and security events (logs of any security breaches or suspicious activity, such as unauthorized access attempts or data breaches). Resource Utilization Data includes batch jobs (the amount of system resources consumed by batch processing jobs), and Time-sharing Data (e.g., in systems where multiple users share the same resources, data is collected on each user's resource consumption). Configuration and Setup Data includes system settings (the configuration parameters for the mainframe, such as network configurations, system paths, and environment variables) and software versions (information about the versions of operating systems and application software installed and running on the mainframe). Backup and Recovery Data includes backup status (information related to backups, such as successful/failed backups, time of last backup, and any issues encountered during the process) and recovery logs (data about system recovery processes, such as recovery from failures or restoring data from backups). Capacity Planning Data includes usage Trends (historical data that helps track long-term trends in resource usage, aiding in forecasting future needs and scaling decisions), and workload analysis (data to identify and analyze workload patterns, helping to allocate resources more efficiently in the future).

Management data of the mainframe may also include accounting or business function data. For example, management data is available to determine which user or department used particular resources and for what purpose. This information may be used for billing purposes, in an enterprise environment. This information may be important to a user and the user may not want to store such information in the mainframe permanently (so it can be transformed and transmitted to a database in a non-mainframe environment).

Various tools and systems are used for collecting management data within a mainframe environment. For example, IBM's z/OS Management Facility (z/OSMF) is an interface for managing and monitoring z/OS mainframe systems. System Management Facilities (SMF) is a component of z/OS that generates logs and records about system activity, performance, and usage. Hardware Management Console (HMC) is a console used to manage hardware resources and gather data about system health and performance. Many third party monitoring tools are also available, from entities like BMC, CA Technologies, and others that provide more advanced or specialized management data collection and analysis capabilities.

Management data has many purposes. For example, monitoring (track system performance in real-time and identify potential issues before they become critical), troubleshooting (diagnose and resolve issues quickly, such as system crashes, slowdowns, or security breaches), optimization (optimize resource allocation, improve performance, and reduce system downtime), and compliance (ensuring the system adheres to relevant standards, regulations, and internal policies).

In general, management data in a mainframe system is all the relevant information that helps in maintaining the health, performance, and security of the system, that is separate from the data stored for use by applications in performing the operation of the mainframe (e.g., mainframe datasets).

At step 955, the database data is transmitted to the target database. The manner in which the database data is transmitted to the target database may depend, at least in part, upon the capabilities specific to the target database. In particular embodiments, the JDBC driver associated with the target database is used in the transmission of the database data to the target database.

In particular embodiments of this disclosure, all of the hardware and software necessary to implement the teachings herein, including the features and functions described with regard to the methods of FIGS. 8 and 9 may reside withing the mainframe environment. For example, the software for performing these features and function may reside within mainframe 11 and may be embodied in applications 9 and may employ processors 22 and/or storage 18 in operation. This provide advantages of efficiency, speed and accuracy, since it does not require that the mainframe dataset be ported to a different platform (e.g., non-mainframe environment), processed into a database format, and then transmitted to a database. Instead, the teachings disclosed herein allow for the processing and formatting of the mainframe dataset and/or management data within the mainframe environment or on the mainframe housing the data itself, and transmitted directly to the database and/or the application running the database.

Thus, data of mainframe dataset may be read, transformed and inserted into the database in a single transaction on the mainframe. This is accomplished on the mainframe (where the data of the mainframe dataset resides), in the same place, all as a single, logical unit of work, all streamlined (end to end). Performing this work within the mainframe environment also allows a user to leverage mainframe security and leverage database security. For example, login info (e.g., username/password) may be utilized within the mainframe environment, and/or sent directly from the mainframe to the database. This allows a user to receive an indication that they are unable to do something that they are trying to do as the work is being accomplished.

This configuration of having a direct connection between the mainframe and the target database allows for immediate feedback during a job. For example, a user may receive an indication that a batch of data loading to the database, or an individual row of data being loaded to the database was not successful. Having the ability to receive this information in real time, and not waiting until the entire mainframe dataset is transformed being anything is loaded into the database, allows for a faster response (corrective action by the user) without having to wait until the entire job (load of data to the database) was attempted or completed before receiving such feedback.

In embodiments in which the JDBC driver is installed within the mainframe environment and/or on the mainframe on which the mainframe dataset resides, the mainframe is able to communicate directly with the database. For example, the JDBC driver is essentially a pipe between the mainframe and the database environment that allows the mainframe to communicate with the database in a standardized way, with a JDBC driver specific to the database (e.g., connect, insert row, read record, etc.).

In some embodiments, the features and function described above is accomplished by software running on an IBM ZiiP processor(s). This reduces cost since such activity is not typically counted in licensing models of IBM, so it's much cheaper to accomplish within the mainframe environment. IBM standards dictate what is or is not eligible to be accomplished on IBM ZiiP processors. Most or all of the features and functions described herein may be accomplished on ZiiP processors. However, in some instances, the features and function will be distributed amongst a ZiiP processor(s) and other general purpose processor(s) within the mainframe environment (general purpose processor computing is generally counted in licensing meter models and is therefore more costly).

The teachings disclosed herein also allow for data synchronization within and outside of a mainframe environment. For example, when data is amended, edited, or updated in one environment (e.g., mainframe environment), the teachings disclosed herein allow for the data to automatically replicate to the other environment (non-mainframe environment) without user intervention or drafting of proprietary code, and vice versa. Thus, for example, at step 960, it is determined whether data synchronization is required in order to synchronize data in two separate environments. This step can also occur at the beginning of the method of FIG. 9, and may be what initiates the need to transmit some or all of a mainframe dataset to a non-mainframe environment (e.g., relational database).

In accordance with another aspect of the present disclosure, a method is provided that allows for transactions executing on one platform to be transparently routed to another computer for execution, even where the “target” computer (computer that the transaction is being routed to) is of a different architecture or operating system. For example, a transaction executing on a mainframe platform transparently routed to a non-mainframe computer in order to access, copy and/or update stored data for execution during the transaction, or vice-versa.

The teachings of the present disclosure provide software and/or hardware that enable mainframe servers and systems to connect to many types of non-mainframe storage, ranging from cloud storage systems (e.g., Amazon S3, Google Drive, Microsoft OneDrive, Dropbox, Box and many others) to low-cost hardware storage devices (e.g., those made available from Quantum, Netapp, Dell/EMC and others).

In accordance with particular embodiments, the teachings herein provide for concurrent access to multiple data sources. For example, a mainframe software product may enable applications to access multiple data sources in parallel within a single application. Further, an application may be used to read records from Amazon S3 storage and write to Dropbox, or any other mix of data sources.

In particular embodiments, bidirectional and automatic data transformation may be provided. For example, non-mainframe data (data stored in a non-mainframe environment) may be automatically transformed into a format that can be processed by mainframe applications, and vice-versa. For example, a mainframe software product in accordance with the teachings herein may enable a spreadsheet written by Microsoft Word and stored in Microsoft OneDrive to be directly processed by a mainframe application. In some embodiments, automatic data transformation enables the records of the spreadsheet to be transformed from UTF-8 text encoding to appear in a text format that's friendly (e.g., usable, readable, etc.) to most mainframe applications.

The teachings herein may also enable cloud applications and SaaS services to be “consumed” by mainframe applications. In other words, applications running on a mainframe may be able to access, applications and/or data stored in non-mainframe environments. For example, the popular open-source GIT source code management system may be accessed by mainframe DevOps tools as an alternative to retaining source code and other artifacts solely on the mainframe.

The teachings of the present disclosure may also provide for secure operation, including integrated authentication, authorization checking and data privacy enforcement. For example, a mainframe software product may work in conjunction with mainframe security software and policies to control exactly what data any user or application can reference. In parallel, the mainframe software product may also support the security protocols implemented by the storage provider, managing credentials, encryption and so forth as required. A site connecting to Amazon S3 storage, for instance, may use Amazon credentials to control the S3 storage resources a particular mainframe system is able to access, while mainframe security policies limit the resources any particular mainframe user can access.

In at least one embodiment, a VSAM emulation layer that enables mainframe storage client 110—managed data sources to be used as storage for mainframe VSAM files may be provided. In these embodiments, mainframe applications written to use IBM's VSAM capabilities (e.g., APIs) have the ability to place their data on a data source managed by the mainframe software of the present disclosure.

In other embodiments, a device emulation capability may enable the mainframe software product of the present disclosure to provide a device-specific interface to applications like tape devices. For example, certain mainframe applications (such as some popular backup/restore programs) perform low-level I/O in a device specific way that only operates with tape devices. Teachings provided herein enable such mainframe applications to communicate with practically any other mainframe application or non-mainframe application and/or storage device.

The flowchart and block diagrams in the figures illustrate the architecture, functionality, and operation of possible implementations of systems, methods and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

What is claimed is:

1. A method for data transformation, comprising
monitoring mainframe management data in a mainframe environment in real time;
receiving messages of the mainframe management data;
accessing a mainframe dataset in the mainframe environment;
reading metadata defining the structure of data in the mainframe dataset;
identifying a target database outside of the mainframe environment;
parsing, within the mainframe environment, the data in the mainframe dataset into a series of field names and values;
transforming, within the mainframe environment, the messages of the mainframe management data into a format readable by the target database;
transforming, within the mainframe environment, the data in the mainframe environment into database data comprising table, column and row identifiers; and
transmitting the transformed messages and the database data from the mainframe environment to the target database.

2. The method of claim 1, wherein the mainframe management data comprises information that is used to monitor operation of a mainframe server within the mainframe environment.

3. The method of claim 1, wherein the messages of the mainframe management data comprise messages related to security events.

4. The method of claim 3, further comprising:
identifying capabilities specific to the target database; and
wherein the transforming, within the mainframe environment, the data in the mainframe environment into database data comprising table, column and row identifiers, is based at least in part upon the capabilities specific to the target database.

5. The method of claim 1, further comprising:
receiving, from a third party, information regarding a preferred structure of the target database; and
wherein the transforming, within the mainframe environment, the data in the mainframe environment into database data comprising table, column and row identifiers, is based at least in part upon the information regarding the preferred structure of the target database.

6. The method of claim 1, further comprising:
identifying capabilities specific to the target database; and
wherein transmitting the database data from the mainframe environment to the target database transmitting data to database environment comprises sending data in multiple batches based upon the capabilities specific to the target database.

7. The method of claim 1, further comprising:
identifying a JDBC driver associated with the target database;
reading a JDBC driver associated with the target database into the mainframe environment; and
wherein transmitting the database data from the mainframe environment to the target database comprises transmitting the database data from the mainframe environment to the target database using the JDBC driver.

8. A computer configured to transform data, the computer comprising:
a processor; and
a non-transitory, computer-readable storage medium storing instructions that when executed by the processor cause the computer to perform:
monitoring mainframe management data in a mainframe environment in real time;
receiving messages of the mainframe management data;
accessing a mainframe dataset in the mainframe environment;
reading metadata defining the structure of data in the mainframe dataset;
identifying a target database outside of the mainframe environment;
parsing, within the mainframe environment, the data in the mainframe dataset into a series of field names and values;
transforming, within the mainframe environment, the messages of the mainframe management data into a format readable by the target database;
transforming, within the mainframe environment, the data in the mainframe environment into database data comprising table, column and row identifiers; and
transmitting the transformed messages and the database data from the mainframe environment to the target database.

9. The computer of claim 8, wherein the mainframe management data comprises information that is used to monitor operation of a mainframe server within the mainframe environment.

10. The computer of claim 8, wherein the messages of the mainframe management data comprise messages related to security events.

11. The computer of claim 10, wherein the computer-readable instructions further cause the computer to perform:
identifying capabilities specific to the target database; and
wherein the transforming, within the mainframe environment, the data in the mainframe environment into database data comprising table, column and row identifiers, is based at least in part upon the capabilities specific to the target database.

12. The computer of claim 8, wherein the computer-readable instructions further cause the computer to perform:
receiving, from a third party, information regarding a preferred structure of the target database; and
wherein the transforming, within the mainframe environment, the data in the mainframe environment into database data comprising table, column and row identifiers, is based at least in part upon the information regarding the preferred structure of the target database.

13. The computer of claim 8, wherein the computer-readable instructions further cause the computer to perform:
identifying capabilities specific to the target database; and
wherein transmitting the database data from the mainframe environment to the target database transmitting data to database environment comprises sending data in multiple batches based upon the capabilities specific to the target database.

14. The computer of claim 8, wherein the computer-readable instructions further cause the computer to perform:
identifying a JDBC driver associated with the target database;
reading a JDBC driver associated with the target database into the mainframe environment; and
wherein transmitting the database data from the mainframe environment to the target database comprises transmitting the database data from the mainframe environment to the target database using the JDBC driver.

15. A computer program product, comprising:
a computer-readable storage medium having computer-readable program code embodied therewith, the computer readable program code comprising:
computer-readable program code configured to monitor mainframe management data in a mainframe environment in real time;
computer-readable program code configured to receive messages of the mainframe management data;
computer-readable program code configured to access a mainframe dataset in the mainframe environment;
computer-readable program code configured to read metadata defining the structure of data in the mainframe dataset;
computer-readable program code configured to identify a target database outside of the mainframe environment;
computer-readable program code configured to parse, within the mainframe environment, the data in the mainframe dataset into a series of field names and values;
computer-readable program code configured to transform, within the mainframe environment, the messages of the mainframe management data into a format readable by the target database;
computer-readable program code configured to transform, within the mainframe environment, the data in the mainframe environment into database data comprising table, column and row identifiers; and
computer-readable program code configured to transmit the transformed messages and the database data from the mainframe environment to the target database.

16. The computer program product of claim 15, wherein the mainframe management data comprises information that is used to monitor operation of a mainframe server within the mainframe environment.

17. The computer program product of claim 16, wherein the messages of the mainframe management data comprise messages related to security events.

18. The computer program product of claim 17, further comprising:
computer-readable program code configured to identify capabilities specific to the target database; and
wherein the transforming, within the mainframe environment, the data in the mainframe environment into database data comprising table, column and row identifiers, is based at least in part upon the capabilities specific to the target database.

19. The computer program product of claim 17, further comprising:
computer-readable program code configured to receive, from a third party, information regarding a preferred structure of the target database; and
wherein the transforming, within the mainframe environment, the data in the mainframe environment into database data comprising table, column and row identifiers, is based at least in part upon the information regarding the preferred structure of the target database.

20. The computer program product of claim 17, further comprising:
computer-readable program code configured to identify capabilities specific to the target database; and
wherein transmitting the database data from the mainframe environment to the target database transmitting data to database environment comprises sending data in multiple batches based upon the capabilities specific to the target database.
